(19) United States
(12) Patent Application Publication
(10) Pub. No.: US 2010/0047757 A1
(43) Pub. Date: Feb. 25, 2010

(54) System and method for using interim-assessment data for instructional decision-making

(76) Inventors: Douglas McCurry, Brooklyn, NY (US); Shelley Thomas, Brooklyn, NY (US); Harris Ferrell, Forest Hills, NY (US)

Correspondence Address: MILBANK, TWEED, HADLEY & MCCLOY, 1 CHASE MANHATTAN PLAZA, NEW YORK, NY, 10005-1413, US

(21) Appl. No.: 12/229,342

(22) Filed: Aug. 22, 2008

(51) Int. Cl. G09B 7/00

(52) U.S. Cl. 434/353; 434/322

(57) ABSTRACT

A method for processing an assessment document. In one aspect, the method may include generating the assessment document having layout information, a test area, and an identifier corresponding to a student, receiving a scanned image of the assessment document after the assessment document has been administered to the student, identifying the test area in the scanned image using the layout information, identifying the student using the identifier in the scanned image, and displaying the test area in response to a request to display the test area for the student.

### FIELD OF THE INVENTION

The present invention generally relates to an interim-assessment platform, and more particularly, to a system and method for generating and analyzing interim-assessment data and implementing in response thereto a detailed plan of action based on a user's preferences.

### BACKGROUND OF THE INVENTION

Student-assessment systems for tracking the educational performance of students are used by teachers, professors, and administrators in school systems throughout the United States. Teachers, administrators, and other education professionals implement student-assessment systems based on multiple-choice, short-answer, and essay tests. Scanning systems such as Scantron® may be used to scan and store students' responses to test questions for future analysis. Today's scanning systems usually scan only the students' responses to multiple-choice questions and do not provide a method for teachers to track students' responses to open-ended questions. While a teacher may score short-answer and essay questions by hand, then manually correlate the student's performance with his or her score on a multiple-choice section, this is a cumbersome process that does not facilitate easy tracking of the concepts a student mastered or failed to grasp.

After scanning and storing the students' test answers, some student-assessment systems utilize computer software to generate static, non-interactive student performance reports containing student's names, test scores, and final grades. These student performance reports may be inadequate for various reasons. Teachers and administrators may wish to analyze an array of student-performance indicia, not just numerical test scores. Teachers must sift through tests and answer sheets by hand just to see, for instance, how and why a student answered a specific type of question incorrectly or what educational topics, concepts, or standards a particular student is having trouble understanding. Furthermore, the student performance reports generated using traditional computer programs provide no system or strategy for improving students' academic performance in response to the data contained in the reports.

For these and other reasons, it may be desirable to have an interactive student-assessment system that may track the progress of students, classes and schools, and may assist in developing data-driven lesson plans to improve students' academic performance in response to data obtained from past performance. This system may assist a teacher or administrator in measuring the efficacy of those lesson plans in an effort to improve student performance on subsequent assessments. It may also be desirable to have an assessment system that may generate comprehensive student performance reports, thereby providing instant access to an array of student-performance indicia in addition to test results and grades. The system may scan not only the multiple-choice questions and answers on a particular test, but may also scan additional portions of the test booklet, including responses to short-answer and essay questions.

### BRIEF SUMMARY OF THE INVENTION

The present disclosure relates to a method for processing an assessment document. In one aspect, the method may include generating the assessment document having layout information, a test area, and an identifier corresponding to a student, receiving a scanned image of the assessment document after the assessment document has been administered to the student, identifying the test area in the scanned image using the layout information, identifying the student using the identifier in the scanned image, and displaying the test area in response to a request to display the test area for the student.

### BRIEF DESCRIPTION OF THE DRAWINGS

Certain features and aspects of embodiments of the present invention are explained in the following description based on the accompanying drawings, wherein:

FIG. 1 is an illustration of the interim-assessment platform architecture according to an aspect of the invention of the present disclosure;

FIG. 2 is a diagram showing functional component dependencies according to an aspect of the invention of the present disclosure;

FIG. 3 is a flowchart of the assessment process of the interim-assessment platform according to an aspect of the invention of the present disclosure;

FIG. 4 is a diagram illustrating the configuration process for the interim-assessment platform framework according to an aspect of the invention of the present disclosure;

FIG. 5 is an illustration of a page of a sample interim assessment according to an aspect of the invention of the present disclosure;

FIG. 6 is a flowchart of an interim-assessment administering and scanning step according to an aspect of the invention of the present disclosure;

FIG. 7 is an illustration of a sample question on an interim assessment according to an aspect of the invention of the present disclosure;

FIG. 8 is an illustration of the mapping process according to an aspect of the invention of the present disclosure;

FIG. 9 is an illustration of a type of student performance report that may be created using the invention of the present disclosure;

FIG. 10 is an illustration of the filtering system used in an aspect of the invention of the present disclosure;

FIG. 11 is an example of a window that may be displayed when accessing a student performance report created using an aspect of the invention of the present disclosure;

FIG. 12 is an illustration of a type of student performance report that may be created using an aspect of the invention of the present disclosure;

FIG. 13 is an illustration of the filtering system used in an aspect of the invention of the present disclosure;

FIGS. 14.A-14.E are sample sections of a data-driven plan that may be created using an aspect of the invention of the present disclosure;

FIG. 15 is an illustration of a window that may be displayed during a scheduling step of a data-driven plan according to an aspect of the invention of the present disclosure;

FIG. 16 is an illustration of a scope and sequence editor according to an aspect of the invention of the present disclosure;

FIG. 17 is an illustration of a display screen for an interim-assessment approval report that may be created according to an aspect of the invention of the present disclosure; and

FIG. 18 is an illustration of a type of improvement analysis report that may be created using an aspect of the invention of the present disclosure.

It is understood that the drawings contained herein are for purposes of illustration only and are not intended to limit the disclosed invention.

### DETAILED DESCRIPTION OF THE INVENTION

In one aspect, the system of the present disclosure may be an interim-assessment (“IA”) platform that may assist education professionals in converting IA data into data-driven instructional plans and providing subsequent analysis of the efficacy of those instructional plans. The IA platform may manage the full cycle of IA definition, creation, administration, scanning, processing, and uploading, with a key focus on the data analysis and instructional planning that teachers undertake as they analyze the results from the IA and adjust their instruction accordingly in the classroom. Various aspects of the present invention will now be described in greater detail with reference to the drawings.

### System Aspects of the Present Disclosure

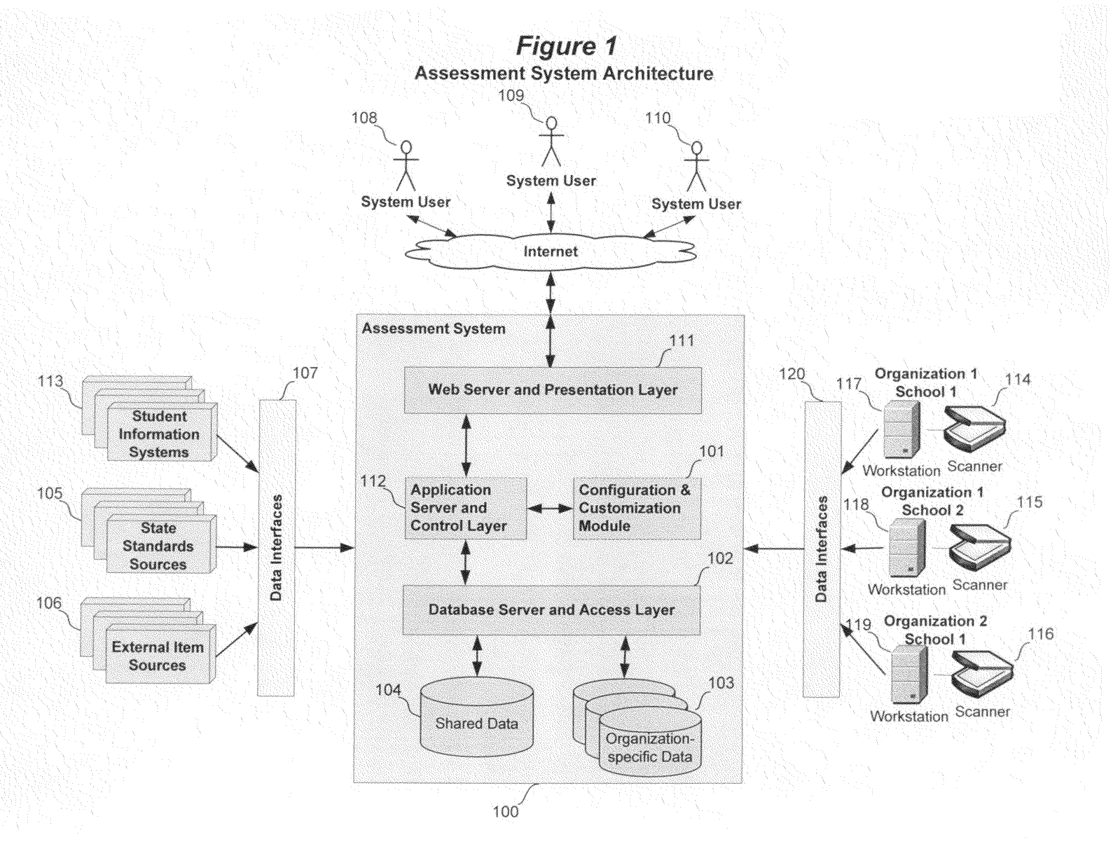

To understand the system aspects of the present disclosure, it may be helpful to refer to FIG. 1. In one aspect, the system may generally include a number of local computers (not shown) used by system users 108, 109, and 110 (e.g., education professionals) in communication with an IA software platform 100 via a network or internet web browser. The local computers may run any operating system capable of supporting a web browser, including Internet Explorer, Firefox, Opera, and Safari. Users may connect to the system via a registered URL.

The system may include a web server and presentation layer 111 to provide HTML navigation to the system users. The web server and presentation layer 111 may comprise standard web server components, such as Apache, Tomcat, or Microsoft IIS, and presentation tools, such as Javascript, AJAX, or ASP.NET. The web server of the web server and presentation layer 111 may manage system user connections and sessions. The presentation tools of the web server and presentation layer 111 may render markup (such as HTML) to requesting browsers, control page layout, and serve up client-side scripts to populate pages with dynamic data. It should be noted that multiple sites running the computer application of the present disclosure on local machines can publish data to the online server.

The IA platform 100 may include an application server and control layer 112. The application server and control layer 112 may employ a standard web application server platform, such as WebLogic, WebSphere, Apache Geronimo (open source), or Microsoft.NET, and may include proprietary business logic to control navigation, data interaction, and workflow. User navigation may be controlled by an application framework supported by one of these standard web application server platforms.

The system of the present disclosure may include a configuration and customization module 101, which may be integrated with the application server and control layer 112. The configuration and customization module 101 may be implemented as custom code that manages data values used by the application server and control layer 112 to set various parameters such as performance thresholds. The application server and control layer 112 may also specify special logic that controls workflow processes to guide system users through pre-defined tasks such as creating data-driven plans (discussed below).

The IA platform of the present disclosure may include a database server and access layer 102, which may field data requests from the application server and control layer 112 and provide data in return. The database server and access layer 102 may comprise a combination of a database connectivity driver and native SQL queries that retrieve data from one or more databases and return the results in application objects. The database server and access layer 102 may also include a proprietary database schema containing information such as class rosters and student enrollment data.

Additional student descriptor data (e.g., demographics and educational program association) may be obtained from student information systems (“SIS”) 113 in order to provide the ability to run certain student performance reports (discussed below). An SIS database 113 may be hosted centrally by districts or locally by individual schools. After student information is uploaded to the system, database procedures in the database server and access layer 102 may be run to check data quality and create exception reports.

The IA platform of the present disclosure may obtain lists of educational standards and other information from state standards sources 105, which are databases that may be provided by state agencies or other third-party content providers. The IA platform may also obtain lists of questions to be used on IAs and other information from external item sources 106, which are databases that may be provided by third-party educational organizations and other third-party content providers. Information may be downloaded from sources 105, 106 through, for example, a web site in a standard format (such as CSV) and uploaded into the system, tagged with metadata, and stored in a shared data 104 repository.

Data obtained from state standards sources 105, external item sources 106, and SIS database 113 may be uploaded to IA platform 100 through a data interface 107. Data interface 107 may be fully automated to establish system-to-system connectivity using a pre-defined protocol to connect, exchange data, and handle errors. Data interface 107 may be less automated and exchange data via structured files in which the source system exports data to a file in a pre-defined format, which may be imported into the system using built-in database tools.

After IAs are administered to students, answer sheets and test booklets may be scanned using scanners 114, 115, 116, which may be located in schools and connected to workstations 117, 118, 119. The IA platform may implement data interface module 120 to upload student test results to the IA platform 100. The IA data may be uploaded to a staging area in the database server and access layer 102, after which the data may be processed by a proprietary program that translates scanned test scores into meaningful student results data. The scanned IA results, which may be obtained from multiple educational organizations, may be stored in organization-specific data 103 repositories.

### Interaction of Functional Components

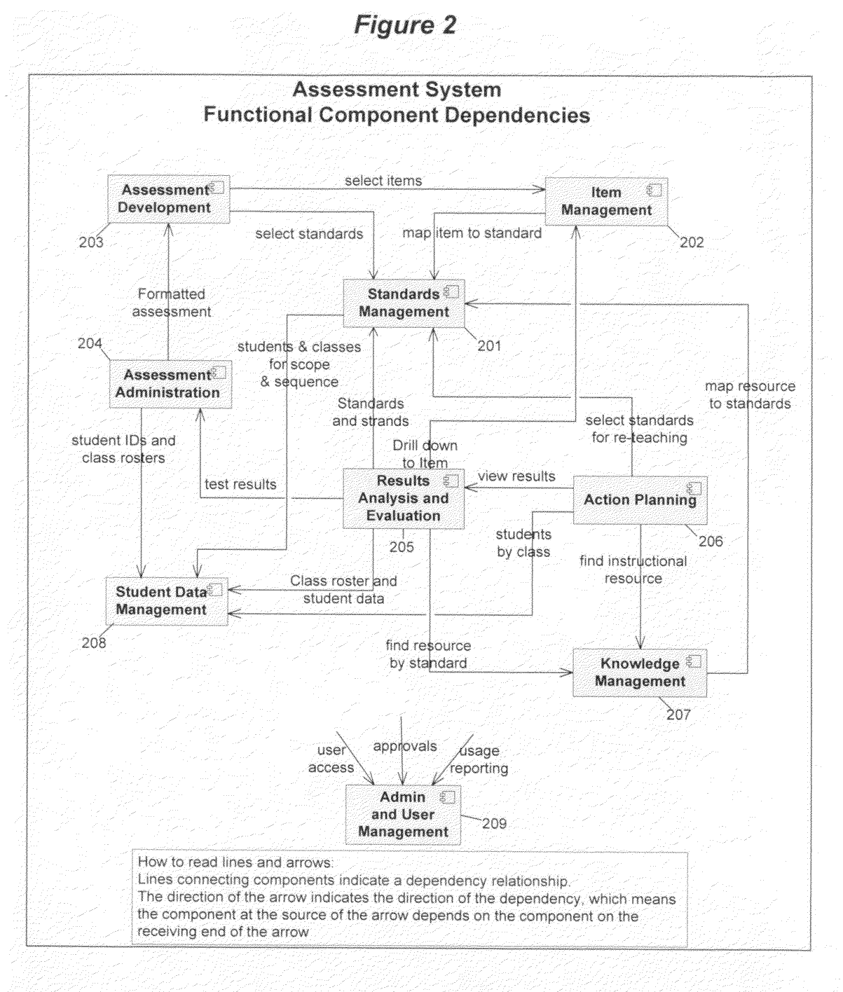

FIG. 2 provides an overview of an interaction between the functional components of the invention of the present disclosure. In FIG. 2, the Standards Management component 201 may assist in managing and maintaining standards for IAs and support scoping and sequencing of those standards. These standards may be those state standards loaded from the state standard sources 105 of FIG. 1 and/or standards added directly into the system. Standards may be used to define instructional coverage, or scope, of IAs as well as sequences in which standards will be taught and assessed. Test questions (or “items”) may be created to fulfill one or more standards and may be linked to those standards for analysis purposes.

The Item Management component 202 of FIG. 2 may assist in managing and maintaining questions that may be used on an IA. Item Management component 202 may aid the user in creating, tagging, formatting, and mapping questions to standards. It may allow the user to import external questions from external item sources 106 from FIG. 1. Item Management component 202 may also support the user's ability to share questions across organizations and allow organizations to maintain their own set of IA questions.

An item may contain a question prompt that the student is asked to answer (or task to complete), an alignment to a standard that the question is measuring, and a point-value associated with correctly answering the question. There may be many additional attributes of a question dependent on question type, including answer choices for multiple-choice questions and scoring rubrics for open-ended questions. Multiple-choice questions may also have associated reading passages, graphs or images, which the student may need to read/review in order to have sufficient information to answer the question prompt. A single reading passage may have many subsequent questions linked to it. Once a question is used by an organization in a specific IA and that IA is subsequently administered to students (thereby generating student performance data for that item), the question may be maintained for future reporting.

The Assessment Development component 203 of FIG. 2 may assist the user in creating IAs and selecting standards and questions for use in those IAs. It may aid the user in creating, editing, publishing, and maintaining IAs. IAs may be tied to a specific point in time within a scope and sequence and designed to measure student progress in mastering the set of standards that should have been learned by the students at the point in the school year when the IA is administered. Each IA may be part of a sequence (e.g., 5th-grade math IA series with tests #1 through #5). Each subsequent IA in a series may cover an increasing number of standards—all standards from the previous IA cycle plus the new standards covered since the prior IA cycle. IAs may include questions that are associated with one or more standards defined in the scope and sequence.

Given the set of standards that the IA could measure, the user may browse, review, and select from a set of appropriately aligned questions available in accessible question banks. Alternatively, the user may create and save a new question to be used in the IA and align the new question to the appropriate standard. The user may also add additional elements to the IAs, such as teacher or student directions or elements required for subsequent administration of the IA. Once the IA has been constructed, it may be reviewed and edited. Individual questions within the IA may be edited and modified, too. Organization-specific formatting (e.g., font and line spacing) may be applied and maintained for all questions in the IA. The IA may be saved as a complete document and a full collection of questions.

The Assessment Administration 204 component may assist the user in administering, scanning and scoring IAs, and processing and uploading results and images of student responses to the online system for reporting, analysis, and planning. Once an IA is published, it may be ready for administration to students. To administer the IA a student may receive a test booklet and a uniquely identified response and answer form that may be scanned, processed, and uploaded into the online system. The test booklet and the answer form may be the same document or separate documents. The Assessment Administration component 204 may manage the translation of the digital IA created by the Assessment Development component 203 to a hard copy of the test booklets that the students complete. The hard copy form may then be translated back into digital form for processing and conversion into student performance data for subsequent analysis, reporting, and planning. Images of actual student responses to questions may be captured and uploaded to the system for online retrieval and viewing.

The Results Analysis and Evaluation component 205 may assist with viewing and analyzing student results and evaluate efficacy of the teaching, learning, and testing process. This component 205 may provide the means for aggregating and disaggregating student performance on individual questions, groups of questions, standards, strands (i.e., groups of standards), and overall IAs. The system may analyze student data on an individual basis or in groups such as a class, school, or region.

The Action Planning component 206 may assist with creating data-driven instructional action plans (“data-driven plans” or “DDPs”) based on student and class results. This component 206 may enable users to use DDPs to inform instructional planning, improving the understanding of and response to student learning needs. Additionally, the DDPs may be a mechanism for supervisors, such as deans and principals, to review, support, critique, and monitor the intended work of teachers. Based on threshold parameters set in the system for aggregate standard performance and individual student performance, the Action Planning component 206 may walk users through a structured process to create a DDP that may help them prioritize their instruction over the subsequent period of time until the next IA to deliver the high-value instruction the group of students require based on the results from the most recently administered IA.

The Knowledge Management component 207 may aid the user in managing the knowledge resources that may be stored and accessed in the system of the present disclosure. These knowledge resources may be created/loaded, disseminated, accessed, and used by different users in the system. The component 207 may facilitate connecting relevant resources to teachers who would most benefit from the learning contained in the resources as they apply to their classroom and instructional situation. In this way, as organizations using the system may develop and codify best instructional practices, that learning may be disseminated to the network of users in the system. This may occur by having IA results linked directly to the most applicable knowledge resource and by teachers searching or browsing for resources that may help them as they are creating their DDPs.

The Student Data Management component 208 may allow the user to import, manage, and maintain student-related data required for the IA lifecycle and determine how to associate student-class-teacher-school relationships with associated IA performance data. Students may need to be associated with classes, teachers, schools, and grade levels so that data in the reports and planning tools reflects groupings that correspond to those in actual classrooms and schools. The source data of these relationships may be a school system's SIS 113 in FIG. 1. In order to avoid double data-entry, which is time consuming and error prone, these student-teacher-class-school-grade level associations in the system may be driven by those associations in SIS 113. Any additional demographic or student-program data may also come from SIS 113.

The Administration and User Management component 209 of FIG. 2 may assist in managing system users, policies, metrics, and approval processes. User management functionality may be focused on defining access rights, or permissions, for different features and views of data. For example, individual student performance may be available to teachers and principals, while overall class performance may be available to all users associated with a school. User permissions may be flexible and granular—such as submitter, reviewer, and approver—in various processes, including DDPs, question creation, IA creation, and instructional resources approval. Managing system metrics may include such things as defining performance bands that partition student results and defining what usage statistics to collect and view.

Component Interaction

The Standards Management component 201 may be used to transmit the standards, as well as information regarding the scope and sequence of those standards, to other functional components. When questions are created in the IA platform, they may be mapped to standards. When IAs are developed, the IAs may be built according to the standards that they should cover based on the IA cycle during which the IA is being administered. The IA author may then select questions using Item Management component 202 that are aligned to the relevant standards.

Once the IA is developed, it may be ready to be administered to students. The Assessment Administration component 204 may be used to generate a hard copy of the test booklets. The component 204 may allow the user to pull student class rosters from the Student Data Management component 208 in order to assign which students should complete which test answer forms. The students may then complete the questions on the IAs.

After students complete the IAs, the user may scan and process the IAs using Assessment Administration component 204. After scanning and processing, the Results, Analysis, and Evaluation component 205 may assist the user in generating student performance reports based on the student performance data generated by the IAs. The reports may be organized and aggregated according to the class rosters and student data transmitted by the Student Data Management component 208. Relevant standards may be shown according to the scope and sequence. Question details may be retrieved during analysis to drill down into what aspects of the standard the students did or did not understand as measured by each question.

After a user has analyzed results, the user may create a DDP for the user's classroom. The DDP may initially be populated by the student performance results according to the thresholds set by the policies managed by the Administration and User Management component 209. The grouping of students in the DDPs may be generated by the class rosters according to the Student Data Management component 208. The standards listed for review, re-teaching, and new teaching (described below) may be organized according to the performance thresholds and the scope and sequence. Once a teacher has completed the DDP for the teacher's classroom, the principal may be informed to review and approve the plan according to the policies set in the Administration and User Management component 209. The Knowledge Management component 207 may contain relevant resources that are aligned to the standards being addressed in the DDPs.

### Establishing Interim-Assessment Framework and Policies

Establishing Basic IA Platform Settings

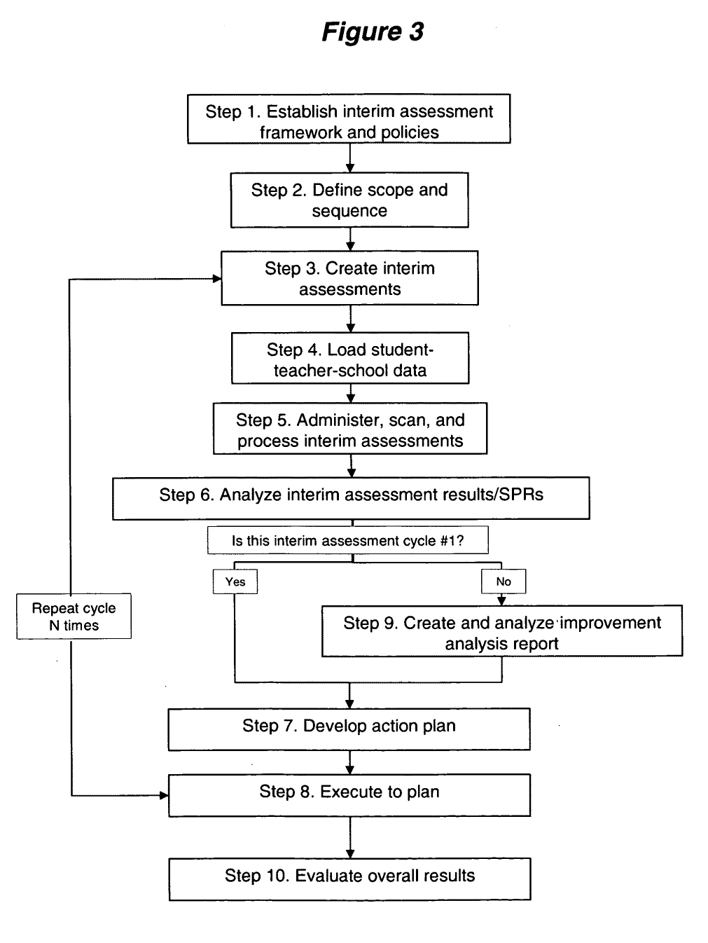

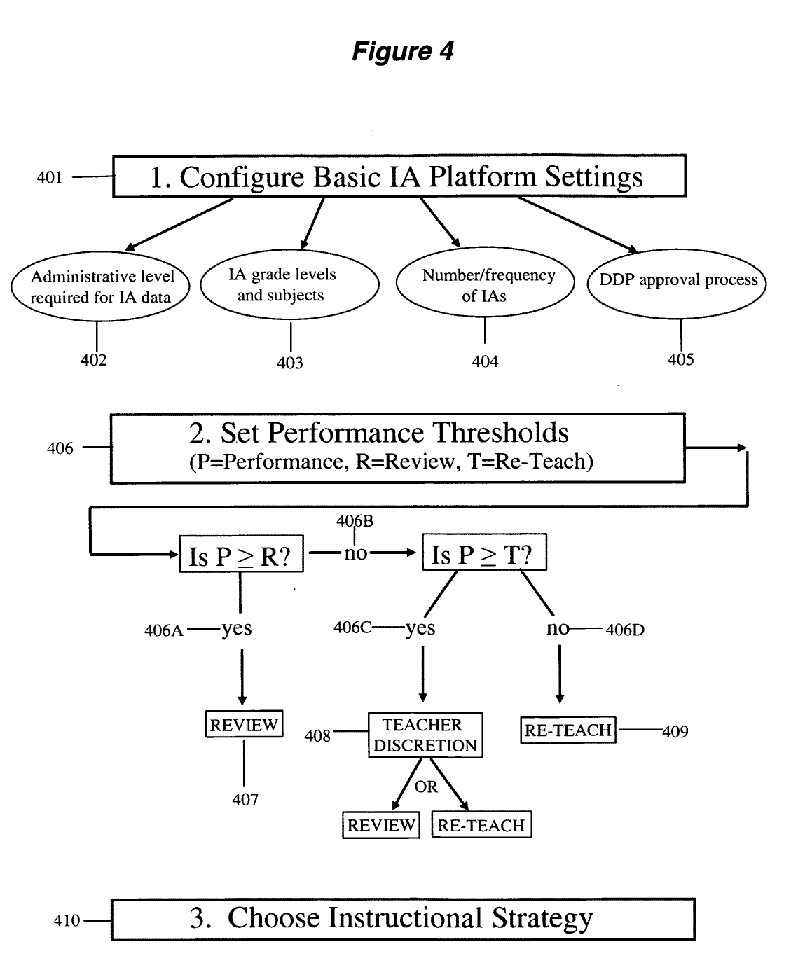

FIG. 3 shows an overview of the IA process implemented according to one aspect of the IA platform and system of the present disclosure. Step 1 of FIG. 3 may include establishing an IA framework. FIG. 4 illustrates the process by which the IA platform framework may be established according to an aspect of the present disclosure. The first step of the process of FIG. 4 includes configuring the basic IA platform settings 401. These basic settings may include such things as the data access levels that a particular system user should have to access the IA platform 402, the grade levels and subjects for which IAs should be administered 403, the number and frequency of IAs that should be administered over a particular time period 404, and the particular process that should be used for approving data-driven educational plans 405.

Setting Aggregate Performance Thresholds

Establishing the IA framework may also involve setting numerical, performance-based thresholds in step 406 that may trigger a default instructional “action” that teachers may be advised to take in the future based on class performance on one or more standards or sets of standards. The default instructional actions may include, for example, reviewing the standards, re-teaching the standards, or reviewing or re-teaching based on the teacher's discretion. The performance-based thresholds may function such that aggregate classroom performance on standards may be compared against the threshold set to determine in which action category the standards will fall. As discussed in greater detail below, a web server and presentation layer may prompt teachers to choose a recommended strategy for performing the default actions in step 410 of FIG. 4.

Referring to FIG. 4, if the determination of whether the aggregate classroom performance (“P”) on a standard is equal to or greater than a pre-set threshold for review (“R”) results in an answer “Yes” 406A, then the standard would qualify as “review” 407 for that classroom. If “No” 406B, and a determination of whether aggregate classroom performance on a standard is equal to or less than a threshold for re-teach (“T”) yields an answer “No” 406D, then the standard would qualify as “re-teach” 409 for that classroom. For those standards where the answer to whether the aggregate classroom performance is between the thresholds for “review” and “re-teach” is “Yes” 406C, that standard would qualify as “teacher-discretion” 408, meaning that in the instructional planning phase a teacher may decide whether to review or to re-teach that standard.

Defining Aggregate Performance

Aggregate performance on a set of standards may be defined as the total points all students actually earned divided by the total points all students could have earned by answering the questions aligned to a specific standard correctly. For example, if there are 10 students in a classroom and there are 4 questions that align to a particular standard (e.g., Standard No. 1) and each question is worth 1 point, then there would be a total of 40 possible points that could be earned for Standard No. 1 (4 questions*1 point each*10 students=40 possible points). If 8 of the 10 students answered all 4 questions correctly, they would collectively earn 32 points. If the final 2 students answer 2 of the 4 questions correctly, they would add an additional 4 points (2 questions*1 point*2 students=4 points). The total points earned by all 10 students would then be 36 points out of 40 possible points, or 90% of the total points possible for that standard. If the threshold to qualify a standard for review is 85% or better, then Standard No. 1 at 90% would have qualified as a review standard.

Another method for defining and calculating aggregate performance on a standard may be based on a percentage of the questions correct. The system user or administrator may define aggregate performance by calculating the number of all questions that align to the same standard which were answered correctly out of the total possible questions that align to that same standard. This method may take into consideration the fact that each question may have a different threshold for points that must be earned by a student to be deemed having been answered correctly.

For example, there may be 4 questions that align to Standard No. 2. Three of the questions may be multiple choice and worth only 1 point. The fourth question may be an open-response question worth up to 5 points, but the open-response question could have a parameter that stipulates for that question that earning 3 or more of those 5 points would be considered having answered the question correctly. The total points possible for a student to earn on these 4 questions would be 8 points. If a student answered 2 of 3 of the multiple-choice questions correctly and scored 3 out of 5 points on the fifth question, he would have earned a total of 5 points out of 8 possible points on those 4 questions ((2 correct multiple choice questions*1 point per question)+(1 open-response question*3 points earned)=5 points). The student would have answered 3 out of 4 questions (or 75%) correctly. If the threshold to qualify a standard for re-teach is 70% or less and the threshold to qualify a standard for review is 85% or above, then Standard No. 2 would have qualified as a “teacher discretion” standard under the methodology of defining aggregate performance as the percent of questions correct. The methods described above are for illustration only, and the invention of the present disclosure may accommodate any method for determining aggregate performance that is based on class or individual student performance.

Setting Individual Student Performance Thresholds

Numerical thresholds can also be set for student performance bands and triggered based on an individual student's overall IA score (total points earned out of total points possible). For example, for all students whose scores are below 70% on a particular standard or on the overall IA, the software application can categorize the students as “Not Proficient.” Likewise, the software application can define all students whose scores are between 70% and 85% of points possible as “Proficient” and all students who score above 85% as “Advanced.” The student performance thresholds may, but are not required to, be aligned with the aggregate class performance thresholds, and the methods used to determine the student's performance may be the same as or different than the methods used for determining aggregate class performance. The number of student performance bands may be the same as or different than the number of class performance bands.

These aspects of the present disclosure are merely illustrative and are not intended to limit the claimed invention; a system user may designate organizational policies that consider a variety of default actions and thresholds in placement of or in addition to those mentioned above. And although the invention of the present disclosure may be practiced for IAs, it may also be utilized for homework, quizzes, finals, class elections, polls, or other activities by which student responses are recorded for analysis. The invention of the present disclosure may also be utilized in non-student, non-educational forums such as at, for example, a workplace in which a IA platform is needed to record answers to employee surveys.

### Defining Scope and Sequence of an Interim Assessment

In accordance with the present disclosure, education professionals may establish what standards should be covered in their classes during the school year and the order and sequence in which the standards will be tested so that the software can be a useful tool in the education process, as shown in step 2 of FIG. 3.

Obtaining Standards

FIG. 1 illustrates how the system of the present disclosure may obtain the stored standards (and questions) that may be selected to be tested on IAs. Database server and access layer 102 of FIG. 1 may receive the standards from either a pre-populated test bank created by the system user's organization (i.e., organization-specific data 103) or from a shared database that allows access to information provided by other organizations (i.e., shared data 104). In addition, many states publish a series of academic standards that define the expectations of student learning for most grade levels and subjects. The IA platform may access a database 105 from the state, local government agency, or other third-party content provider that stores these standards as well as other resources used by the agencies for assessing student performance. Additional standards, questions, and educational resources contained in other external databases 106 may be accessed by the IA platform of the present disclosure.

Scope and Sequence Editor

FIG. 16 illustrates a window for a “scope and sequence editor” that may be displayed by the software program of the present disclosure and used by the system user or administrator to assign standards to particular IAs in which the standards may first be tested. The scope and sequence editor may allow the user to designate the number of IAs that may be included in an IA cycle by using the drop-down box 1614. In the example shown in FIG. 16, the scope and sequence has been set to apply to five IAs. The same scope and sequence of a set of standards may, but is not required to, be applied to an entire course (e.g., semester-long or full school year) for a given year.

The scope and sequence editor of the present disclosure may include a matrix data table 1600 that contains a list of standards (by number) 1604, the names of the standards 1605, and the “strands” (or groups) of which the standards are a member 1606. The scope and sequence editor may allow the system user or administrator to select a new standard to add to the list of standards to be tested by selecting a drop-down box 1602. By selecting drop-down box 1602, the system editor may provide the user with a list of stored standards. The system user or administrator may also create their own standard or edit stored standards by selected the “Create/Edit Standards” button 1603. Each assessed standard may be broad or specific depending on the subject matter being assessed.

For each standard, the editor may allow the system user or administrator to select an IA cycle on which they want the standard to be initially tested by selecting a drop-down box in the fourth column 1607 and choosing a specific IA number. This standard may then be available for testing on any subsequent IA cycle. In the fifth column 1608, the editor may allow the user to input a number that identifies where in the sequence of standards within a particular IA the user wants each standard to be tested. Here, the system user has set standard R.01 to be the first standard tested on IA#1, R.02 to appear starting with IA#2 and to be the second standard tested on IA#2, R.03 to appear starting with IA#3 and to be the third standard tested on IA#3, and R.04 to appear starting with IA#4 and to be the fourth standard tested on IA#4.

In column six 1609, the editor may identify which standards may or may not be removed from table 1600. The system may automatically prevent a user from removing a standard for a variety of reasons, including, for example, when a question pertaining to the standard has been included in an IA already administered to the class or in an IA set to be administered in the future. In order to remove a standard set to be included in a future IA, the user may first have to delete the questions pertaining to the standard from the IA. Those standards that the user may not remove may be designated by a “cannot remove” button 1610, and those standards that the user may remove may be designated by a “remove” button 1611 in column six 1609, which the user may click to remove standard R.03. If the user clicks a cannot remove button 1610, the system may create a display window that identifies the IA number(s) and question number(s) in which the relevant standard is being tested. The data table 1600 may be updated with changes made by the system user or administrator that, for example, affect the scope and sequence of the IAs, by selecting the “Update” button 1612. The changes made using the scope and sequence editor of FIG. 16 may be saved and prepared for viewing, for example, by a dean or administrator, by clicking the “Release this scope and sequence for viewing” check box 1613.

Organizing and Tracking Standards

The computer application of the present disclosure may automatically identify and track the IAs in which a particular standard will and can appear. For example, if a standard is sequenced to appear first on IA#3, then no questions on IA#1 or IA#2 would measure that standard. When IA#3 is created, questions linked to standards designated for IA#1, IA#2, and IA#3 may appear. As noted below, in the data driven instructional planning process that a teacher may undertake for IA#2 after having had the chance to analyze IA#2 data, the IA platform may notify the teacher of the new standards that will be measured on IA#3. This may allow the teacher to plan for the new content instruction in addition to the review and re-teach planning he or she must do for prior standards.

In another aspect of the present disclosure, the IA platform may have a framework for automatically organizing the standards and questions covered in the IAs. For example, certain standards may be designated as “power standards” because they appear more frequently on state tests or are gateway standards that students must master in order to be prepared for subsequent content and mastery of other standards. These standards may be prioritized and sequenced so that a teacher of a particular grade and subject may be aware of the expectation of what standards students may be required to master by a certain point in the school year (e.g., by IA#1, IA#2, IA#3, and so on).

The scopes and sequences of IAs may be stored, copied, and modified using the computer application of the present disclosure for administering to students in subsequent school years.

### Creating an Interim Assessment

Selecting Interim-Assessment Questions

Step 3 of FIG. 3 may include creating and building an IA. The teachers and administrators may create IAs consisting of “multiple-choice” and “open-ended” questions to test the individual educational standards. Multiple-choice questions generally have a distinct, finite set of “bubble-able” answer choices that may be designated by letters, numbers, formatted text strings, or images. Open-ended questions may include many variants of short-answer, fill-in-the-blank, matching, free-response, and essay questions. Each IA may contain questions relating to a plurality of standards on various concepts and topics that may be pre-selected or chosen by the education professional. Questions may be assigned to measure student learning of specific standards such that the students' successful completion or response to each question may indicate a level of understanding of the associated standard(s) to which the question may be aligned.

As shown in FIG. 1, an application server and control layer 112 may organize and exchange data between the web server and presentation layer 111, the configuration and customization module 101, and database server and access layer 102. Using web server and presentation layer 111, system users may access stored questions and answers from a pre-populated test bank stored by the software application of the present disclosure or a teacher's own work in creating his or her own questions. The test bank may include a database of questions created by a third-party organization 104 or from a database of questions used by other teachers from the system user's organization in prior school years 103. A test editor may also be used by system users to create and store their own test questions.

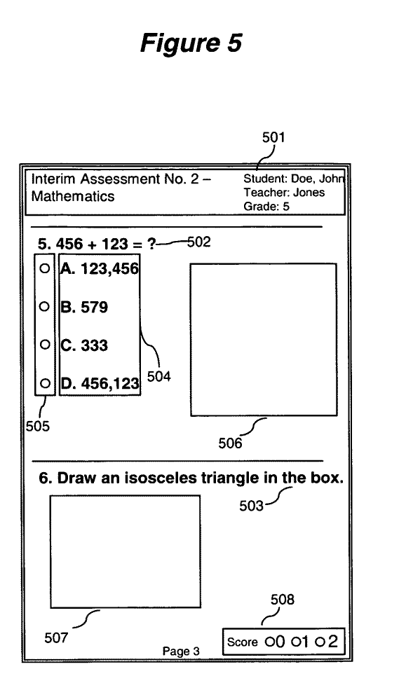

An example of an IA according to an aspect of the present disclosure is shown in FIG. 5. This IA may comprise student, teacher, and class identification information 501. This particular IA, which is IA#2 in a series of IAs, was created for Teacher Jones's 5^{th}-grade mathematics class. The IA may include a plurality of multiple-choice questions 502 and open-ended response questions 503, or a combination thereof, on a variety of standards. For instance, a multiple-choice question 502 may ask what the correct response is for an addition problem out of a number of possible responses listed 504, and an open-ended question 503 may ask the student to draw an isosceles triangle inside a predetermined area.

Interim-Assessment Format

The software application of the present disclosure may allow system users to format the questions included on IAs themselves, select individual questions that have already been formatted, or use pre-formatted IAs. FIG. 5 shows a type of format that may be used for an IA according to an aspect of the invention of the present disclosure. For a multiple-choice question, the teacher may include a number of response bubbles 505 for the student to choose the correct response, as well as space 506 that the student may use to show how he or she came to the response. The open-ended questions may include a response area 507 in which the student places his or her response and a scoring area 508 where a grader would mark the student's score for the open-ended question.

The questions and answer choices for the IAs may include formatted text, images, tables, and graphs. Additional formatting specifications may be applied to questions, including but not limited to the number of lines available for a student response after a short-answer question, the number of pages to include for a student response after an essay question, the vertical width between lines to compensate for the grade level of the students (e.g., increased width for elementary school students to compensate for their writing abilities), and the font and font size of the answer choices for multiple-choice questions. The IAs created using the software application of the present disclosure may also include student instructions, teacher instructions, and reading passages on an IA.

The software application of the present disclosure may save a formatted IA as a digital image (such as a TIFF) file for subsequent viewing of the IA questions and answer choices when, for example, the system user wants to view a particular IA question during an analysis phase. A single page of an IA may be displayed at the user's request, or an individual question on an IA may be stored and subsequently displayed by itself. For example, if a user wants to view question #5 on an IA, the user may ask the software application to display question #5 by itself and the software application may have the ability to do so. This aspect of the present disclosure is explained below in further detail.

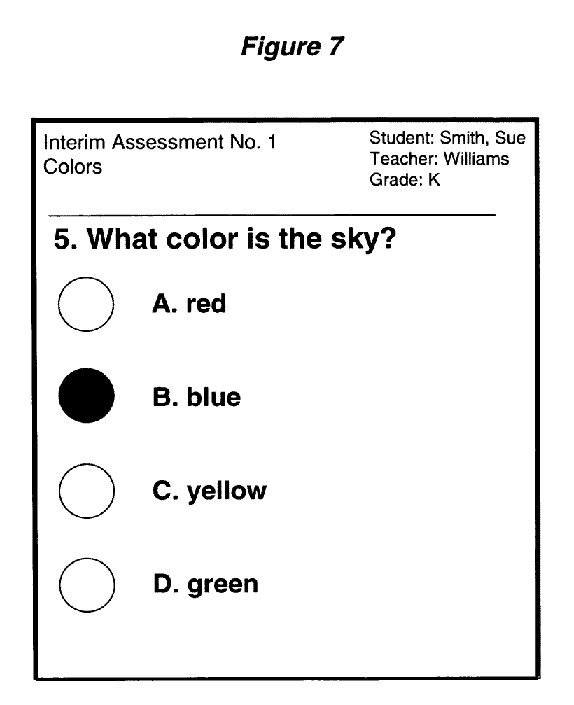

In another aspect of the present disclosure, special IAs may be created for younger students or students with learning disabilities who may have trouble with the small, closely printed bubbles required on traditional machine-readable answer sheets due to a low tolerance for stray marks. FIG. 7 illustrates an example of a specialized IA with a large-print option that may be created according to the present disclosure. As shown in FIG. 7, the present system can print IAs with large font, large response bubbles, and bubbles that are spaced farther apart. This aspect of the present disclosure may prevent grading errors that might occur, for example, when a student unintentionally fills two bubbles instead of one as a result to their inability to keep their writing in between the lines. Using the software application of the present disclosure, the IAs may be previewed online as they are being created as an image file (such as a PDF file) that reflects what the IAs would look like if they were printed in a test booklet.

Point Value Designation

Questions may be assigned different point values depending on their difficulty. Each question may have a number of answer bubbles associated with it in the test booklet based on the question type and point value. For example, the computer application of the present disclosure may create an IA as shown in FIG. 5 that may include four bubbles 505 for a multiple-choice question #5 having four answer choices 504. A student may fill in one of these bubbles when designating the answer he or she believes to be correct. For open-ended questions, the system may generate a teacher scoring box 508 at the end of each question in which a teacher can mark a bubble corresponding to the number of points a student earned in responding to the question. For example, if the point value of the question is up to two (2) points, the teacher's scoring box may contain three bubbles (i.e., the maximum point value plus one). The software application of the present disclosure may be used to label the three bubbles “0” to “2.”

The software application of the present disclosure may be used to include an additional parameter for open-ended questions that represents the minimum score needed for the questions to be considered correct. For example, considering a question having a maximum point value of five (5) points, the system user may define the minimum point value of at least four (4) points to be considered correct. This additional parameter facilitates subsequent analysis when teachers review how many points each student earned as well as which questions were answered “correctly” or “incorrectly.”

Teacher's Edition

In one aspect, the system may generate a teacher version of an IA test booklet. While all test elements may be formatted identical to the student version of the test booklet, the teacher version may include a designation of each standard that each question measures, the correct answer in multiple-choice items, and a sample response to the open-ended questions. For open-ended questions, the teacher version may also show the point value that has been designated as the minimum score for a student to be considered to have answered the question correctly.

Unauthorized Access

The IA platform of the present disclosure may be configured to prevent unauthorized persons from editing an IA. For example, a system administrator may lock the IA platform so that only he or she may edit an IA once the IA is finalized and published. The IA platform may also be configured such that once a test is administered, a database administrator can only modify data or elements of the IA. This aspect of the invention of the present disclosure may protect against inadvertently invalidating the student response data.

### Loading Data for Interim-Assessment Student Identification

According to step 4 of FIG. 3, an aspect of the invention of the present disclosure may include loading student, teacher, and school identification data into the IA platform. Each student may uniquely be associated with a published test booklet so that the responses in the test booklets may correctly be assigned to the right students. In order to accurately correlate the student with his or her unique test booklet, one aspect of the invention of the present disclosure provides for a database that contains information for identifying the students with their teachers, subjects, classes, and schools. Such a database is illustrated as the SIS database 113 of FIG. 1. The student identification information contained in the SIS database 113 may be uploaded to the IA platform through data interface 107.

A data bridge may exist between the SIS database 113 and the data interface 107 of the IA platform. This data bridge may allow the IA platform to query the SIS database to determine if any of the students' information has changed, and if it has, to update the data stored in the IA platform to take account of the new information. For example, if a student moves from Professor John's Section I to Professor Jane's Section II, the school may update its SIS database to record the change. When IA platform 100 queries SIS database 113, the IA platform may update its own database to delete the student's association with Professor John's Section I and add the student to Professor Jane's Section II. Any IA data subsequently associated with that particular student may be associated with Professor Jane's Section II. It should be noted that the IA platform may allow a single student to be associated with multiple classes and multiple IAs (e.g., a single student may concurrently be associated with a math IA, a reading IA, and a science IA).

### Administering, Scanning, and Processing Interim Assessments

Interim-Assessment Preparation

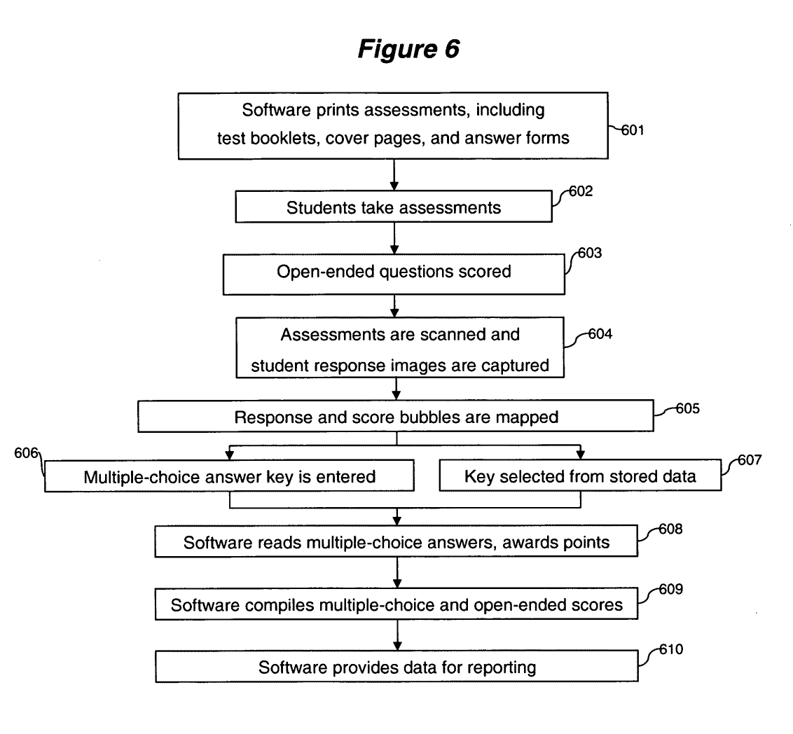

A further aspect of the invention of the present disclosure may relate to a process for administering and scanning answer booklets that may contain students' responses to both multiple-choice and open-ended questions, as shown in step 5 of FIG. 3. The administering and scanning aspect of the IA platform of the present disclosure may include a series of steps illustrated by way of example in FIG. 6. In step 601, the software application of the present disclosure may generate an IA which may include a test booklet, cover pages for each test booklet that contain a unique identifier, such as a bar code, with the relevant identifying information for each student and test, and/or an answer form. Once the cover page is attached to a student test booklet, the IA platform may later be able to recognize which test booklet it is about to process and which student's responses are contained in that test booklet. In another aspect of the present disclosure, the software application may generate unique test booklets for each student that include unique identifiers, such as bar codes, without the need for preparing separate cover pages for each test booklet. In another aspect of the present disclosure, the software application may generate unique answer forms separate from the test booklet for each student that include unique identifiers, such as bar codes. Multiple copies of the test booklets, cover sheets, and answer forms, may be printed by any standard copier or printer for any number of students that plan to take the IA.

Administering an Interim Assessment

Teachers may administer the IAs to their students in step 602 of FIG. 6. Students complete the IAs, marking their responses directly into the test booklets or answer forms. A marked response may include filling in the bubble associated with the answer the student deems to be the correct answer for a multiple-choice question. For open-ended questions such as essay and short-answer questions, a student may write their answers in the space provided directly in the test booklet or answer form.

Once students have completed their tests and turned them into the teacher, the teacher may review the students' responses to open-ended questions, scoring the quality of those responses against a rubric and bubbling a corresponding score section within the test booklet or answer form next to the response in step 603. For each student's response, the teacher may mark the bubble in the teacher's scoring box (see, e.g., box 508 in FIG. 5) that corresponds with the points the student is deemed to have earned. Multiple-choice answers may be scored by hand or by the computer application of the present disclosure using the questions and answers stored by the test editor after a scanning process.

Scanning and Processing

Once the teacher has finished scoring open-ended questions, the complete test booklet or answer form for each student may be scanned in step 604 of FIG. 6 into a computer database and analyzed by the software of the present disclosure. The scanning system is capable of scanning not only the multiple-choice questions and answers on a particular IA, but the entire test booklet, including the open-ended questions. FIG. 1 illustrates the actual architecture of the scanning system in accordance with an aspect of the present disclosure. Referring to FIG. 1, scanners 114, 115, and 116 may be used to scan IA test booklets populated with multiple-choice questions, open-ended questions, and student responses thereto. The present disclosure may incorporate the use of a commercially available hardware-scanning package traditionally used to scan answers to multiple-choice questions such as Kofax Ascent Capture, Scantron, or Remark. Although three scanners and workstations are illustrated in FIG. 1, more or less may be used in practice according to the present disclosure based on the system user(s) preferences. Using a number of scanners and workstations may provide for batch processing of a large number of IA test booklets at the same time.

A scanner may convert each test booklet or answer form into a unique digital image (such as a TIFF) file. Each digital image file may contain a test booklet or answer form image. Each page of the image file may correspond to its hard copy equivalent, spanning one to many pages including a cover page if present (e.g., page 1 of the image file may be the cover page; page 2 of the image file may be the first page of the test booklet; page 3 of the image file may be the second page of the test booklet; and so on). The digital images created by the scanner may be processed by the software application of the present disclosure and uploaded to a web server and presentation layer 111 where the data may be accessible via web browser-based reporting tools.

The computer application may process the image file by reading the unique identifier and other data in the cover page to determine which IA is being processed (e.g., grade/subject/IA number/school year) and which student (e.g., name or social security number) completed the test booklet or answer form. The computer application may retrieve the configuration file from the server that tells the application how many questions an IA will have, how many questions appear on each page, and how many bubbles are associated with each question. A system user may create a bubble-mapping file (discussed below) that geographically shows the computer application where on the page to expect each answer (and score) bubble for a particular question. Once this bubble-mapping file is created, each subsequent IA may use the bubble map file so that the computer application will know where to look for the bubbles.

In addition, the IA platform may recognize the location of the multiple-choice and open-ended questions and responses on each individual page using layout information, such as the question height, width, and coordinates that is stored when the IA is created (e.g., during step 3 of FIG. 3), from the configuration file. The software program may save the locations of question and response areas, and store those areas as image files for subsequent viewing by the system user during, for example, an analysis of the IA results in step 6 of FIG. 3. The IA question and student response images may be stored in databases and uploaded to the web server and presentation layer 111 of FIG. 1. A single page of an IA may be displayed at the user's request, or an individual question on an IA may be stored and subsequently displayed by itself. For example, if a user wants to view a specific's student response to question #5 on an IA, the user may ask the software application to display the student's response to question #5 by itself and the software application may have the ability to do so.

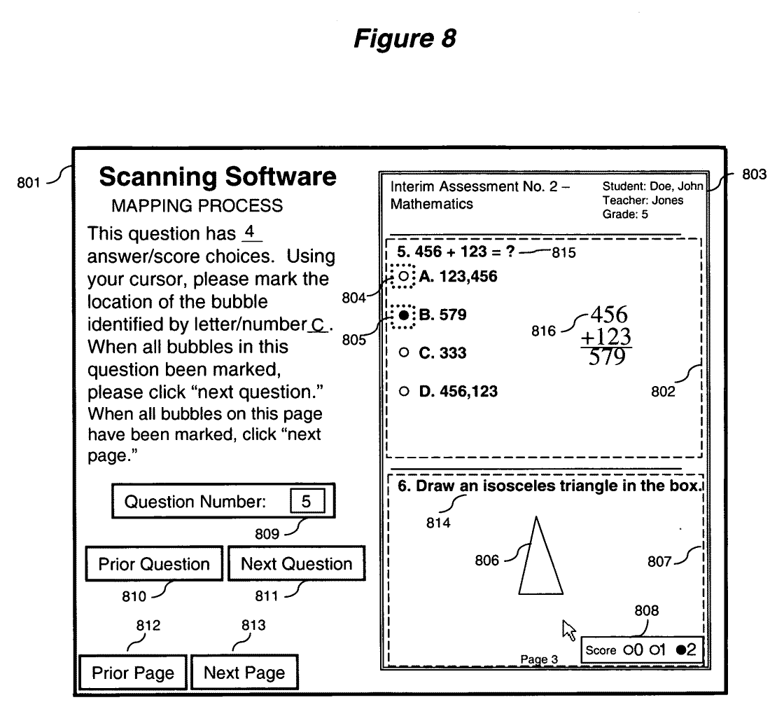

The IA shown in FIG. 8 illustrates the question and response areas that may be captured for subsequent viewing by the software application of the present disclosure. This particular IA may include multiple-choice question and response area 802 and open-ended question and response area 807. The question and response area 802 may comprise the multiple-choice question 815, the scratch work 816 performed by the student when answering the multiple-choice question, and the multiple response choices for the question. The question and response area 807 may comprise the open-ended question 814, the student's response 806, and the score area 808. All of areas 807 and 808 may be captured and stored as image files during this aspect of the present disclosure for subsequent viewing by the system user.

Bubble Mapping Process

Returning to FIG. 6, a mapping process may be implemented in step 605 to tell the software application of the present disclosure where to look on each page of the students' test booklet or answer form for the students' multiple-choice response bubbles and the score bubbles marked by the teacher for open-ended questions. After the software knows where the bubbles will be, it can determine whether the multiple-choice answer is correct and determine how many points to award the open-ended questions. Because students have the same test booklets/answer form for a given IA (e.g., 5^{th} grade math IA#3), only a single test booklet/response form may be needed to map the page areas to the appropriate response and score bubbles for every related test booklet. It is understood that this mapping process may be performed at any time after an IA has been generated, and it is not required that one wait to perform the mapping process until after the IA has been completed. Note that mapping may be done before the IAs are printed using stored image files generated when the IAs are created in step 3 of FIG. 3, or after the IAs are printed for administering to the students and then scanned.

An aspect of the mapping process according to the present disclosure is illustrated in FIG. 8. After an IA is scanned using the invention of the present disclosure, each page of the IA may be analyzed individually to tell the software where to look for the answer and score bubbles for the multiple-choice and open-ended questions. The mapping process may occur inside a software window 801 and may display a series of images of individual pages of an IA 803. The software may display a number showing which question is being dealt with in a question number box 809.

The system user may identify the location of the multiple-choice response bubbles and the teacher's score bubbles for open-ended questions using one or more mapping methods. In the example shown in FIG. 8, the user has identified the location of the bubbles for responses A and B of question #5 by making select boxes 804, 805 around each individual multiple-choice response bubble, one-by-one, using a computer mouse or other human interface device. In another aspect, the system user may identify the bubbles by clicking the bubbles using a mouse cursor or cross hair. After making these selections, the user may be prompted to identify bubbles for responses C and D of question 5. The software program of the present disclosure may record the coordinates for each of the selected bubbles and use them to score the multiple-choice for each successive student's IA.

After the answer and scores bubbles have been identified by the system user for a particular question, the “next question” box 811 may be selected to perform the bubble mapping process for the next question. The software program may automatically go to the next question itself after the final answer or score bubble has been selected by the system user for a particular question. This is possible because for each stored question included in an IA, the system may have stored or a prior system user may have inputted the number of answer choices or possible points into the IA platform. Likewise, for each new question created by the current system user, the user may have inputted the number of answer choices or possible points into the IA platform.

In FIG. 8, after the user has completed the bubble mapping process for question #5, the user may be prompted to identify the score bubbles in question #6 by drawing select boxes around or clicking the score bubbles in the open-ended question score area 808 using a computer mouse or other human-interface device. After identifying the score bubbles, the software program of the present disclosure may record the coordinates for each of the bubbles and use them to score the open-ended questions for each successive student's IA. To go back to a prior question, a “prior question” box 810 may be selected. After all the questions on each page have been dealt with, the “next page” box 813 may be selected to go to the next page of the IA, or the “prior page” box 812 may be selected to go back to make changes to the previous page.

Answer Key and Score Compilation

The answer key for the multiple-choice questions may be entered individually into a database in step 606 of FIG. 6, or retrieved from data stored previously in a database in step 607. The answers may come as part of the test bank from which the original questions were drawn or from a prior test given by the same or another teacher in a different class or school year. The software may then examine the scanned image files and determine whether each multiple-choice question was correctly or incorrectly answered in step 608.

The software may proceed to compile the multiple-choice scores and the open-ended scores that may have been awarded by the teacher. The data may be prepared for sorting, filtering, and analysis by the software used to generate student performance reports in step 610, which are discussed below in greater detail. Many of the aforementioned steps involved in the scanning aspect of the present disclosure can be performed by a variety of educational professionals, including teachers, teacher's aides, and technology assistants.

Student Response and Score Correction

In one aspect, the computer application may prompt the user to correct any questions on which the application could not reliably discern which bubble was marked by the student through a bubble correction process. The user may be presented with an image of the question with the student's marking. The user may then determine which bubble was marked and indicate as such in the computer application. After bubble correction is completed, the data and images of student responses may be uploaded from the workstation to the online servers where the data is compiled and published to the reporting engine.

Another aspect of the present disclosure may provide for an “override” option whereby teachers can override any question score for a student or for a whole class. This option may allow teachers to make exceptions or to nullify an IA question. If a question is nullified, the computer application may disregard it when performing calculations based on or analysis of the students' IA performance.

### Generating Dynamic Student-Performance Reports

After the IAs are administered, scanned, and processed, the results may be ready for analysis by the education professionals as shown in step 6 of FIG. 3. The IA platform of the invention of the present disclosure includes computer software for generating a comprehensive, dynamic student performance report (“SPR”). The software application is able to generate these performance reports by aggregating data on particular questions and standards over a set time period by subject, class, grade, school, district, or region for review by an education professional. The student performance reports may contain a variety of student-performance indicia, including but not limited to the names of students who did or did not take the particular IA, the correct answers to IA questions, the students' responses to IA questions, the number of grade points earned by the students, the percentage of students who scored in certain ranges, the number of standards mastered out of total standards tested, the students' historical performance on IAs, and a comparison of the IA results with state standardized testing thresholds.

Questions by Student Report

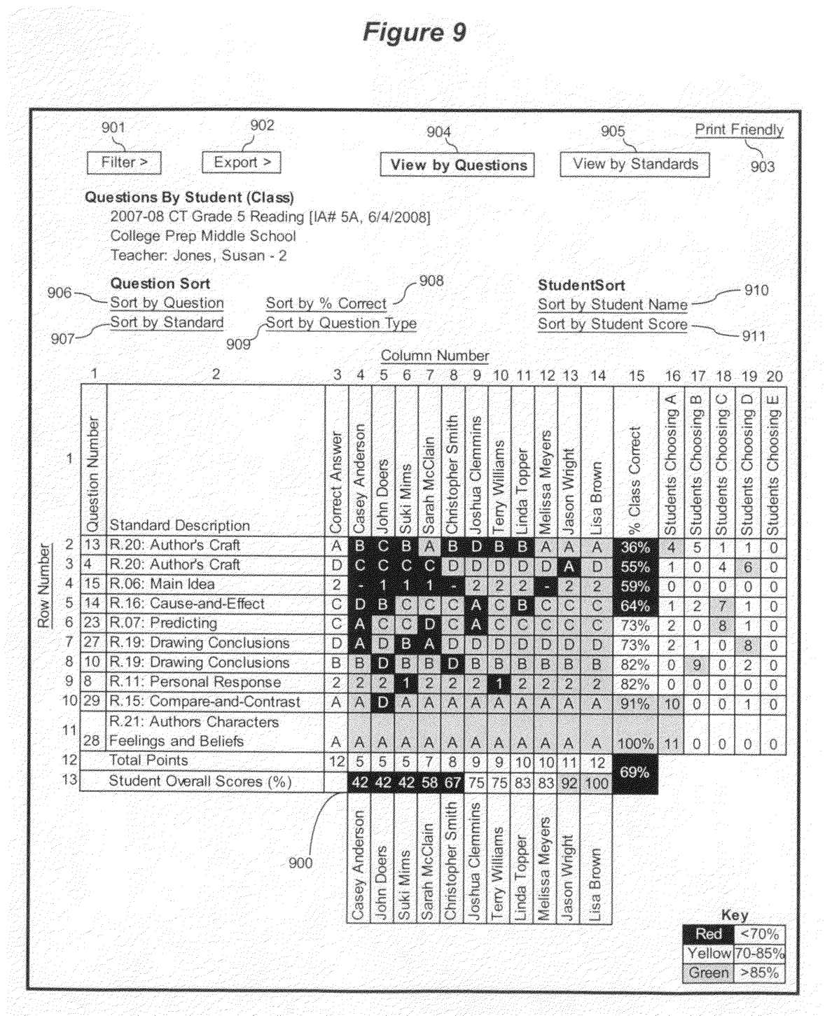

One aspect of the present disclosure is the use of computer software for generating a “Questions by Student” SPR. The “Questions by Student” SPR may be generated for a particular region, IA, grade, subject, school, class, and/or student. An example of a “Questions by Student” SPR is shown in FIG. 9, which displays a single class's performance on an IA in a matrix data table 900. “IA#5” signifies that this particular SPR includes data from the fifth IA in a series of IAs administered to the class. The data table 900 includes all questions tested on the selected IA (column 1), the associated standard that the question was testing (column 2), the correct answer for each question (column 3), each student's answer choice (columns 4-14), the percentage of students in the class that chose the correct answer for each question (column 15), and a count of students that chose a particular answer choice for each question (columns 16-20). The software program may allow the system user(s) to view a question and a student's actual response to the question in, for example, a pop-up window, by clicking on the block containing the student's answer for the particular question in columns 4-14. The bottom two full rows of data table 900 show total points earned by each individual student (row 12), the percentage of total points correct by each individual student (row 13), and the percentage of total points correct for the entire class (rows 12 and 13 of column 15).

The data contained in data table 900 is for illustrative purposes only, and the software application of the present disclosure used to generate the data tables may be configured to include other student information (e.g., demographic information of students) and other indicia of student performance (e.g., the percentage points by which the students had improved since taking a previous IA) based upon the user's preferences. Likewise, multiple descriptors of students (e.g., all sixth grade math students in School A) can be applied at once to sort the IA results displayed in the data table 900. These results can also be analyzed at a point in time (e.g., all students who took IA#1 in October), longitudinally (e.g., all students who took the fifth grade reading IA series in the 2007-2008 school year), and comparatively (e.g., all students who took this specific test from School A compared to all students who took the same test from School B; all students in classroom 201 compared to all students in classroom 202). Using the performance bands for student scores, a user could compare the number of students across classrooms that scored “Advanced” versus “Proficient” versus “Not Proficient” on the overall test.

In the example data table 900, each multiple-choice question used in generating the data table has been defined as being worth one (1) point. Short answer questions may have varying point values from zero (0) to eight (8). Scores of zero may be represented by a dash (—). Questions that were not answered by the student may be identified with a dash (—). The number of points attributed to each question type and the identifiers used for scores of zero and unanswered questions may be changed based upon the user's preferences.

The SPR of the present disclosure may visually draw the user to areas of success and areas of concern, for example, using color coding or shading. Correct answers may, for example, be color coded in gray blocks and incorrect answers in black blocks. The percentages (percent class correct and student overall scores) may be colored according to defined performance bands. According to the bands in this SPR, scores less than 70% are displayed in black, scores between 70% and 85% are displayed in white, and scores 85% and above are displayed in gray. The bands used in this SPR are for illustration only. For example, the number of performance bands can be increased or decreased and the thresholds for placement in those bands may be changed by a system administrator or system user based upon their preferences. Likewise, the colors used for color-coding may be changed according to the user's or system administrator's preferences.

The data tables contained in the SPRs of the present disclosure can be sorted horizontally and vertically. The vertical sort option allows, for example, sorting by question number by clicking the ‘Sort by Question’ button 906, by standard by clicking the ‘Sort by Standard’ button 907, by percent correct by clicking the ‘Sort by % Correct’ button 908, or by question type (e.g., multiple-choice, short-answer, or essay-response) by clicking the ‘Sort by Question Type’ button 909. The horizontal sort option allows for sorting by student name by clicking the ‘Sort by Student Name’ button 910 or by student score by clicking the ‘Sort by Student Score’ button 911. A default may be configured to sort by percent correct (vertical sort) and student score (horizontal sort) and may organize the data in such a way that the questions are sorted in column 1 based on percent class correct (e.g., from lowest to highest), and students' names are sorted based upon their performance (e.g., from lowest performing student to highest performing student) beginning in column 4. This may create bands of black, white, and gray down the ‘% Class Correct’ column and ‘Student Overall Scores (%)’ row. Although the organization of data tables may be changed based upon a user's preferences, this particular organization of data table 900 allows the education professional to easily identify questions that the entire class struggled with, questions that are selected to be reviewed by the class, or individual students that are selected to be placed in small instructional groups.

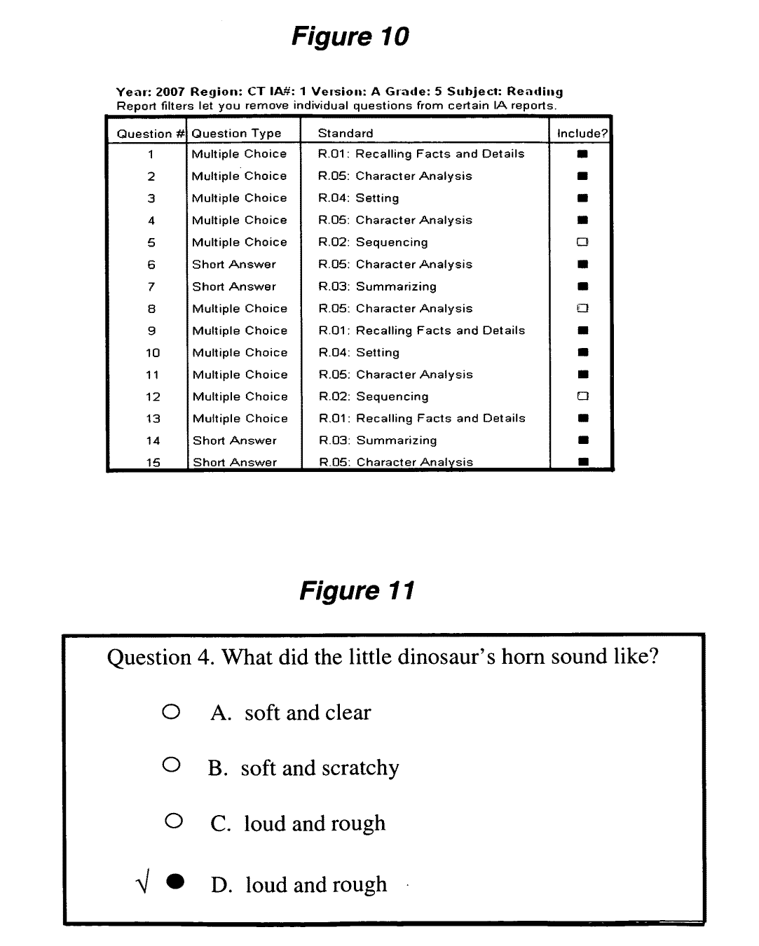

This aspect of the present disclosure may include a filter option. By clicking on the filter button 901, the education professional may be taken to a screen with selection options by question, as shown on FIG. 10. The filter screen may include information about each question such as question number (column 1), question type (column 2), and the standard to which the questions is related (column 3). This particular filter screen corresponds to an SPR generated for IA#1. By selecting/deselecting the boxes in column 4, the user can make decisions about what they want to view in the data tables. The education professional may decide to run the SPR for multiple-choice questions only, or he or she may decide not to include certain questions. For example, the education professional may decide to remove questions on standards that had not been taught to the class before the IA was administered, to view student performance only on multiple-choice questions or short answer questions, or remove questions that the education professional felt were poorly written. Once the filter selections are made and the SPR is displayed with the filter enabled, the total points and percentages on the data table may reflect only the included questions. The re-summarization of totals may allow the education professional to conduct “what-if” analysis on the class (e.g., How would the class have performed if there were only multiple-choice questions on the IA?). The filter may be saved and reused.

The SPR may also allow the user to click on the question number in column 1 of data table 900 in FIG. 9 and view the actual question and answer choices with the correct answer identified in, for example, a pop-up window. Such a pop-up window is shown in FIG. 11 for purposes of illustration. FIG. 11 shows question number 4 of an IA, having a correct answer represented by letter D. A check mark or other symbol may be used to identify the correct response. Viewing the questions and answers may allow the user to make certain decisions about the quality and difficulty of the question and apply that information to the student results. Thus, the education professional may not have to leave this SPR to make evaluations at the question and student level.

This SPR may have an export option. Referring to FIG. 9, by clicking on the export button 902, the education professional may export the data within the SPR to a spreadsheet software application for further analysis. The SPR can be printed by clicking on the ‘Print Friendly’ button 903 at the top of the SPR. This may allow the user to print the SPR easily without needing to adjust margins or worrying about the SPR being divided across multiple pages. The margins may be automatically formatted by the print-friendly feature. The user may also toggle back and forth between the “Questions by Student” SPR and other SPRs (such as the “Standards by Student” SPR discussed in further detail below) by clicking on buttons 904, 905 at the top of the SPR.

Standards by Student Report

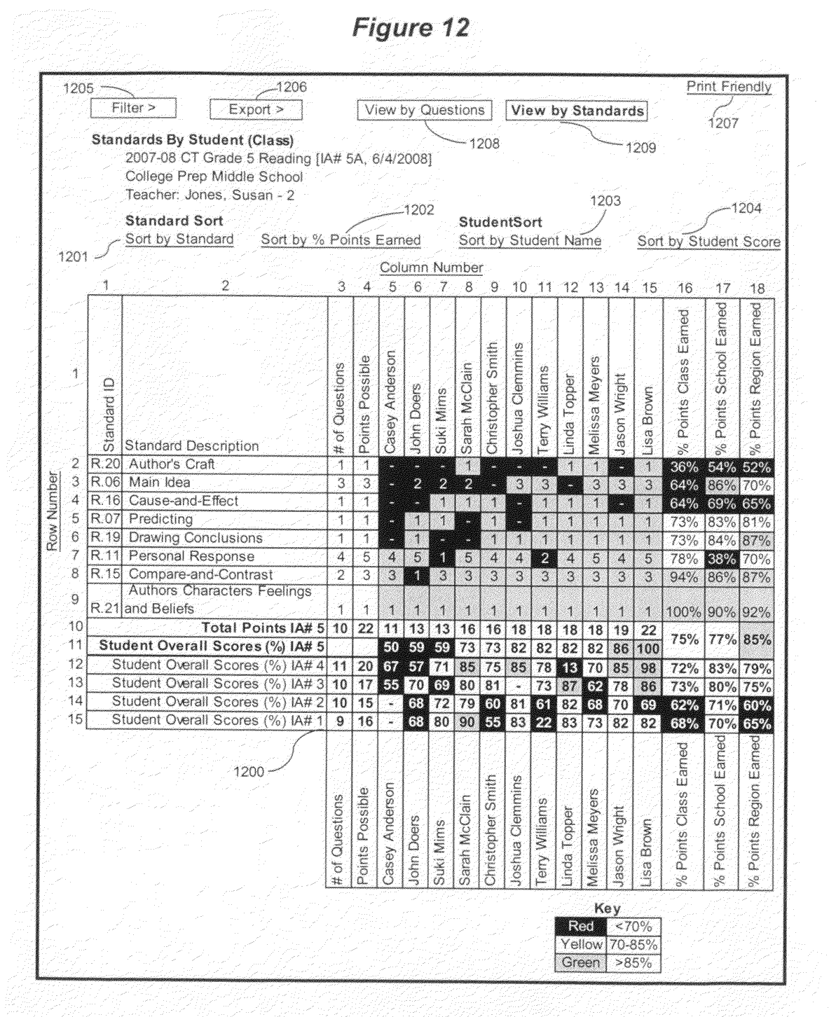

Another aspect of the present disclosure may be the use of computer software for generating a “Standards by Student” SPR as illustrated in FIG. 12. The “Standards by Student” SPR may be generated for a particular region, IA, grade, subject, school, and/or class. The data table 1200 may include all educational standards tested on the selected IA (column 1), a description of each standard (column 2), the number of IA questions used to test each particular standard (column 3), the number of points associated with a particular standard (column 4), and the number of points each student received for a particular standard (columns 5-15). Rows 2-11 of columns 16-18 show the percentage of points earned by the class, the percentage of points earned by the entire school, and the percentage of points earned by the entire region in which the school resides, for each particular standard. Row 12 displays the total number of questions on the IA (column 3), the total number of possible points on the IA (column 4), and the total points earned by each student taking the IA (columns 5-15). Row 13 shows the percentage of total possible points earned by each student (columns 5-15), the entire class (column 16), the entire school (column 17), and the entire region (column 18).

This SPR may also display historical performance by student, class, school, and region for the current school year. Rows 14-17 of data table 1200 shows, for each IA previously administered to the class (i.e., IA#1, IA#2, IA#3, and IA#4), the total number of questions contained in the IAs (column 3), the total number of points possible (column 4), the percentage of total points received by each student (columns 5-15), the percentage of total points earned by the entire class (column 16), the percentage of points earned by the entire school (column 17), and the percentage of points earned by the entire region (column 18). Not every student is required to have historical performance data (e.g., the student transferred to the school mid-year or the student was absent for a particular IA); IAs for which a particular student does not have a score may be represented by a dash (—).

Each multiple-choice question used in generating data table 1200 of this example has been defined as being worth one (1) point. Short-answer questions may have varying point values from zero (0) to eight (8). Scores of zero may be represented by a dash (—). Questions that were not answered by the student may also be identified with a dash (—). The number of points attributed to each question type and the identifiers used for scores of zero and unanswered questions may be changed based upon the system user's or administrator's preferences.

The data contained in data table 1200 is for illustrative purposes only, and the software application used to generate the data tables of the present disclosure may be configured to include other student information (e.g., demographic data of students) and other indicia of student performance (e.g., the percentage of points by which the students had improved since taking a previous IA) based upon the user's preferences. Likewise, multiple descriptors of students (e.g., all sixth grade math students in School A) may be applied at once to sort the IA results displayed in the data table 1200. These results may also be analyzed at a point in time (e.g., all students who took IA#1 in October), longitudinally (e.g., all students who took the fifth grade reading IA series in the 2007-2008 school year), and comparatively (e.g., all students who took this specific test from School A compared to all students who took the same test from School B; all students in classroom 201 compared to all students in classroom 202). Using the performance bands for student scores, a user may compare the number of students across classrooms that scored “Advanced” versus “Proficient” versus “Not Proficient” on the overall test.

The SPR of FIG. 12 may visually draw the user to areas of success and areas of concern, for example, using color coding or shading. Students with point values at mastery may be color coded, for example, using gray blocks and students with point values below mastery using black blocks, as shown on data table 1200 in FIG. 12. Mastery of a standard may be defined in this particular SPR as being dependent on the number of points possible and number of questions tested. Mastery may be different for each standard depending on the system user's or administrator's preferences and may be defined during the test creation process or set with system-wide policies. The percentages (percent points earned for class, percent points earned for school, percent points earned for region, and student overall scores) may be colored according to defined performance bands. According to the bands in this SPR, scores less than 70% are displayed in black, scores between 70% and 85% are displayed in white, and scores 85% and above are displayed in gray. The bands used in this SPR are for illustration only. For example, the number of performance bands may be increased or decreased and the thresholds for placement in those bands may be changed by a system administrator or system user based upon their preferences.

The data tables contained in the SPRs of the present disclosure may be sorted horizontally and vertically. The vertical sort option may allow, for example, sorting by standard by clicking the ‘Sort by Standard’ button 1201 and sorting by the percentage of points earned by clicking the ‘Sort by % Points Earned’ button 1202. The horizontal sort option may allow for sorting by student name by clicking the ‘Sort by Student Name’ button 1203 or by student score by clicking the ‘Sort by Student Score’ button 1204. A default may sort by percentage of points correct (vertical sort) and student score (horizontal sort) in such a way that the standards are sorted in column 1 based on percentage of points earned by the class (e.g., from lowest to highest) and students' names are sorted based upon their performance (e.g., from lowest performing student to highest performing student) beginning in column 5. This may create bands of black, white, and gray down the ‘% Points Class Earned’ column and ‘Student Overall Scores (%) IA#5’ row. Although the organization of data tables may be changed based upon a user's preferences, this particular organization of data table 1200 may allow the education professional to easily identify standards that the entire class struggled with, standards that are selected to be reviewed by the class, or individual students that are selected to be placed in small instructional groups.

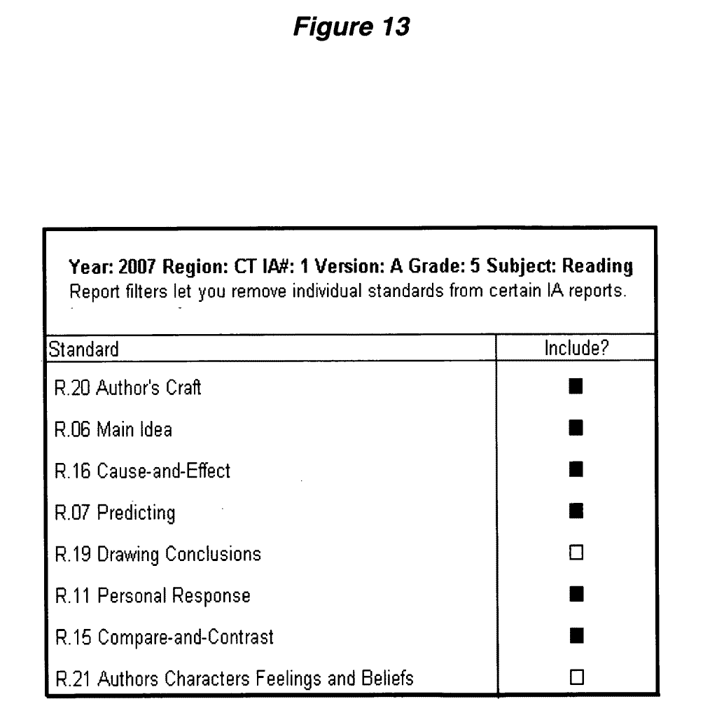

This sample SPR of the present disclosure may also include a filter option. By clicking on the filter button 1205, the education professional may be taken to a screen with the selection options by standard shown on FIG. 13. The filter screen may include information about each standard such as the standard number and a description of the standard (column 1). This particular filter screen corresponds to an SPR for IA#1. By selecting/deselecting the boxes in column 2, the education professional may pick and choose which standards he or she wants to include in the SPR. Once the filter selections are made and the SPR is run with the filter, the total points and percentages on the data table may reflect only the included standards. The re-summarization of totals may allow the education professional to conduct directed analysis on the class (e.g., How did the class do on standards that were taught before the IA was administered?). The filter may be saved and reused.

The SPR shown in FIG. 12 may also have an export option. By clicking on the export button 1206 the education professional may export the data within the SPR to a spreadsheet software application for further analysis. The SPR may be printed by clicking on the ‘Print Friendly’ button 1207 at the top of the SPR. This may allow the user to print the SPR easily without needing to adjust margins or worrying about the SPR being divided across multiple pages. The user may also toggle back and forth between the “Questions by Student” SPR and other SPRs (such as the “Standards by Student” SPR) by clicking on buttons 1208, 1209 at the top of the SPR. The “Standards by Student” and “Questions by Student” SPRs have been used for illustration only, and the invention of the present disclosure covers any and all systems and methods for generating any type of SPR within the scope and bounds of the claims appended hereto.

### Developing Data-Driven Educational Plans

The IA platform of the present disclosure may develop a data-driven educational plan, as shown as step 7 of FIG. 3, that may help increase student academic performance based on the results of an IA as measured against predetermined thresholds chosen by teachers and administrators. The software program of the present disclosure may be programmed with designated thresholds to alert the teacher when students are individually or collectively having trouble understanding particular educational standards. This may allow the teacher to tailor a data-driven educational plan for the most effective use of classroom time. By better understanding what students know, teachers can spend their limited time and resources focusing on problem areas.

Student performance data may automatically pre-populate the DDPs for each teacher's classroom(s) using stored IA policies that define which standards qualify for review, re-teach, and teacher-determined action. When the teacher logs into the system, the software application of the present disclosure may be configured so that the teacher is presented with the start of a DDP uniquely generated for his or her classroom(s) based on the student performance data. The software application may lead the teacher through a multi-step planning exercise to review the data and determine what instructional action the teacher may take in order to fulfill the plan.

Standards for Review

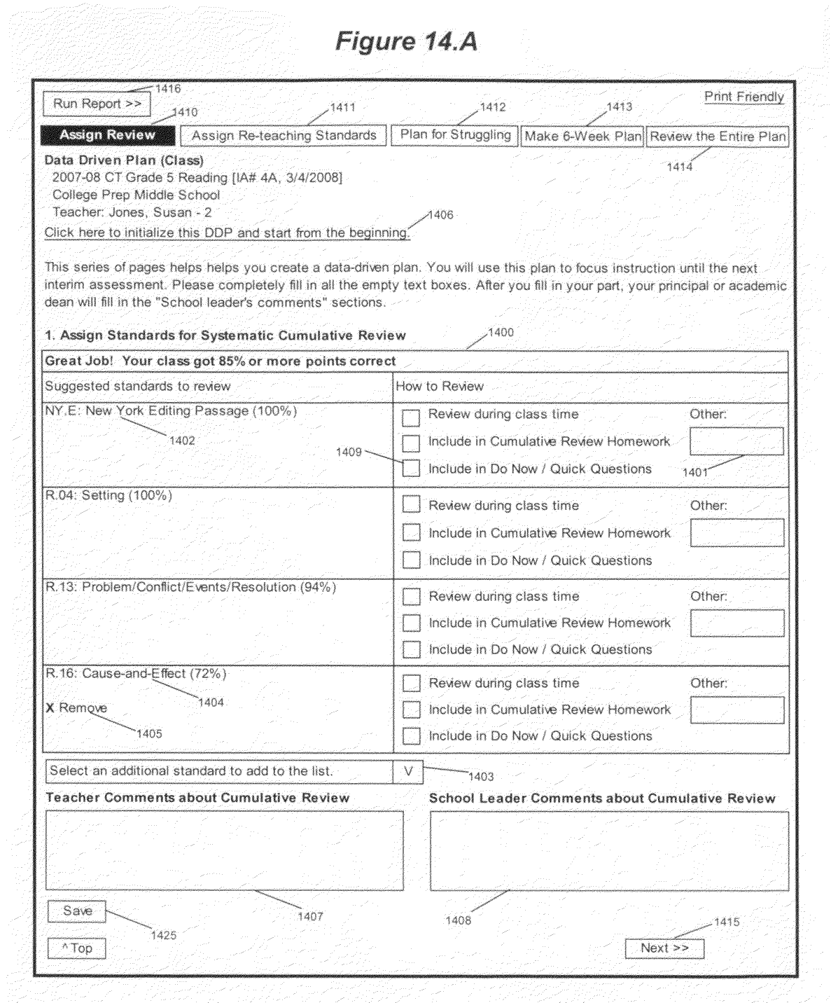

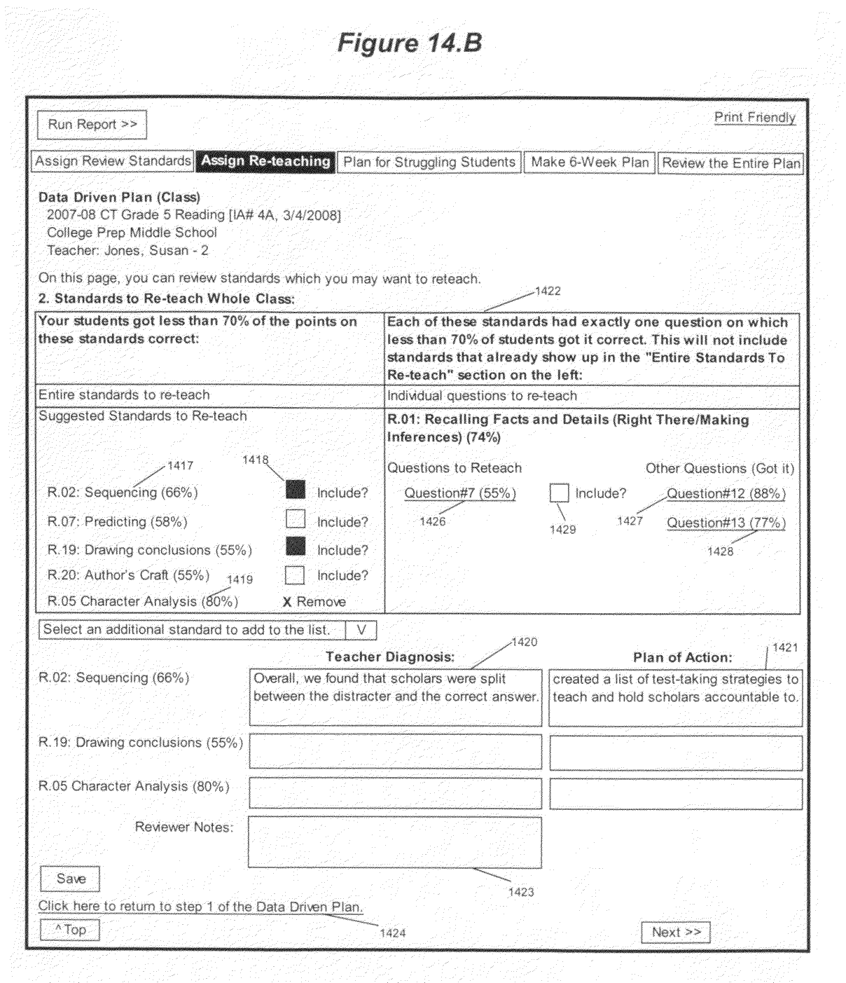

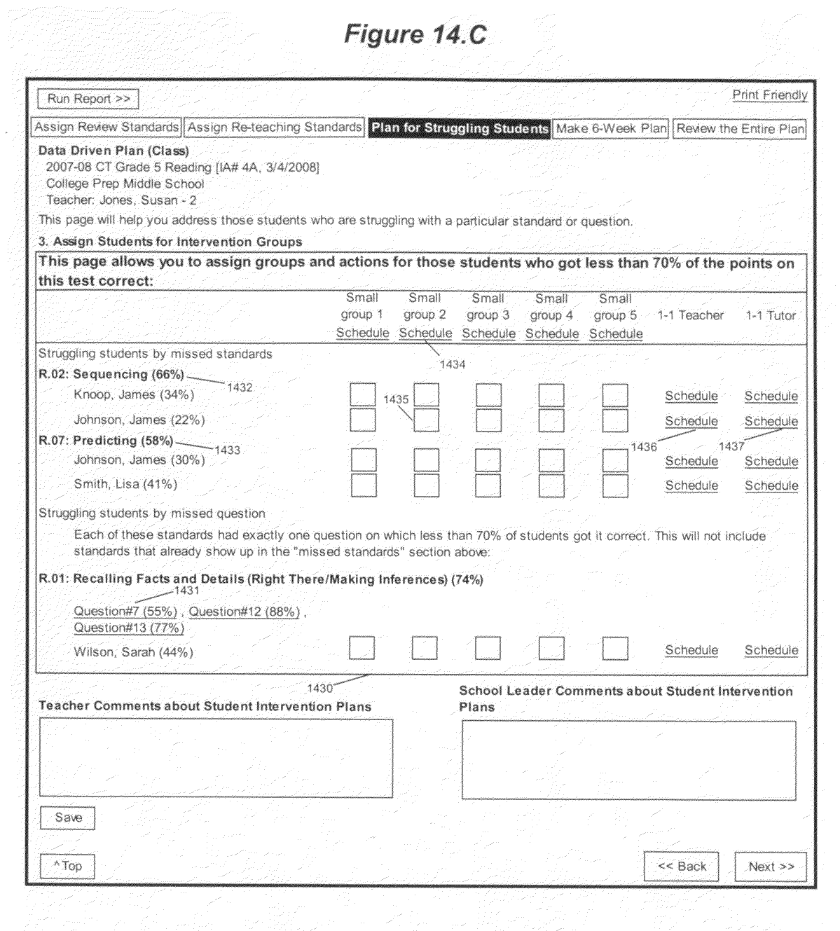

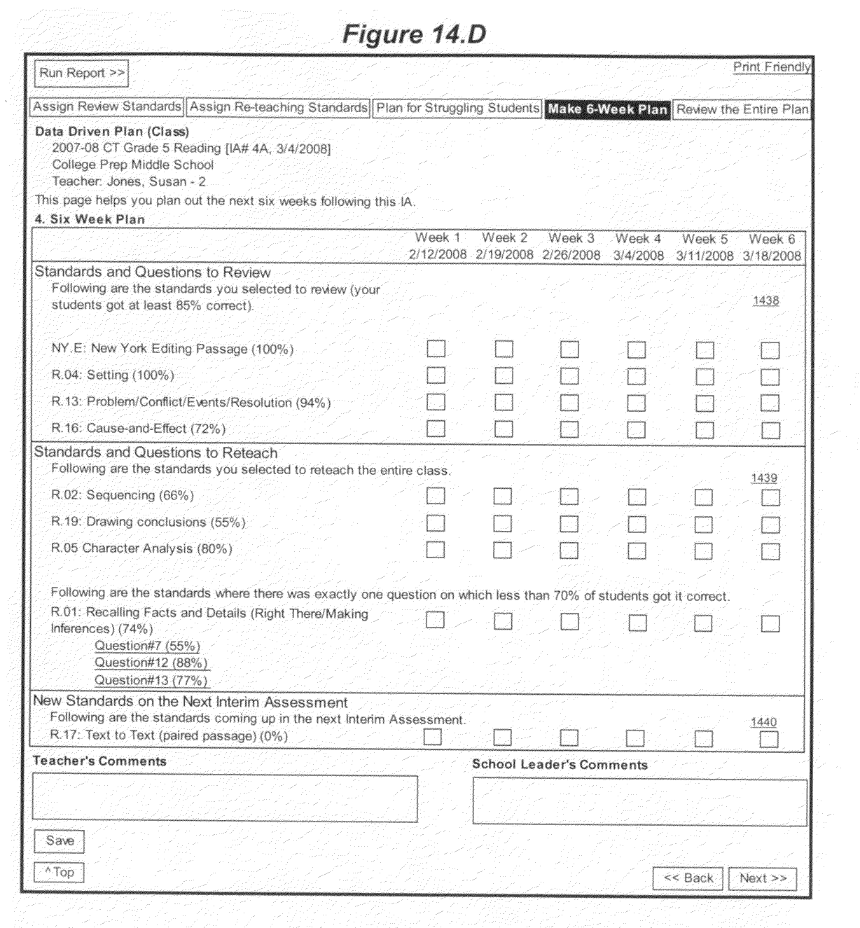

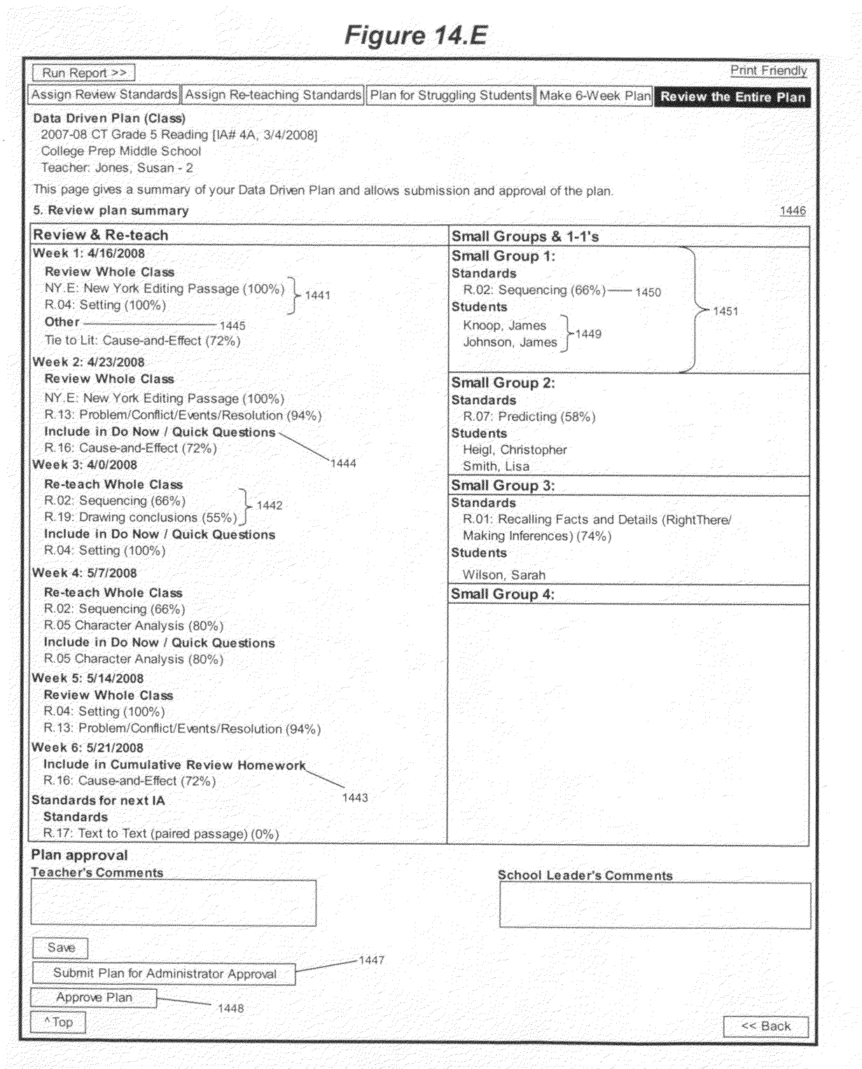

One example DDP created using the software application of the present disclosure may be illustrated in FIGS. 14.A to 14.E. FIG. 14.A shows a page of a DDP that automatically presents a list of standards to the teacher for which the aggregate performance for the classroom of students is at or above the threshold set for review (e.g., 85%). These standards (for example standard 1402) may be shown in column 1 of a data table 1400 under the heading “Suggested standards to review” with their corresponding aggregate performance (by percentage). Here, the aggregate performance for standard 1402 was 100%.

The teacher may have the option to select additional standards from a list of standards that were below the review threshold (85%) but above the re-teach threshold (75%)—in other words, those standards marked for teacher-deternined—in order for the teacher to determine which, if any, of those standards should also be included in the review portion of the DDP. The standards may be selected using the drop-down box 1403, and once selected, may appear in column 1 of data table 1400. At least for teacher-determined standards, such as standard 1404, the software application may provide the user with an option to remove the standard from the list of standards designated for review in column 1 of data table 1400 by clicking a “remove” button 1405.

The software application of the present disclosure may also list the methods that a teacher may use to review the standards in column 2 of data table 1400. Methods for reviewing that may be employed by a teacher may include, for example, reviewing during class time, including in cumulative homework, and including in do-now/quick questions. The teacher may choose the best means of reviewing each standard using this list of default actions by selecting the corresponding response box. If Ms. Jones wanted to administer quick questions to her students as a means for reviewing standard NY.E in FIG. 14.A, for example, she would click response box 1409. The software application may also allow the system user to designate a method of reviewing in addition to these default methods in a text box 1401 in column 2.

By clicking the “Click here to initialize this DDP and start from the beginning” button 1406, a teacher may reset the student identification information as well as the IA results used to generate the DDP. If a student left Ms. Jones' class after IA#4A, for example, the class's performance on the standards listed on data table 1400 may not reflect that particular student's performance once the user clicks button 1406. The DDP may be created from the beginning, using updated student identification information, by clicking the “Run Report” button 1416. The software application may provide comment boxes 1407, 1408 for the teacher and school leader to provide comments on the cumulative review portion of the DDP. The system user may navigate from one portion of the DDP to another portion by clicking the navigation tabs 1410, 1411, 1412, 1413, and 1414, or to the next page by clicking the “Next” button 1415. The user may save his or her progress in creating the DDP by clicking on the “Save” button 1425.

Standards for Re-Teach

According to another aspect of the present disclosure, the DDP may present a list of standards to the teacher for which the aggregate performance for the classroom of students is at or below the threshold set for re-teach (e.g., 70%), as shown in column 1 of data table 1422 of FIG. 14.B. These may be the standards that the classroom has not yet mastered (e.g., standard 1417) and require that the teacher plan full instructional time in order to improve student understanding. The software application may allow the teacher to choose whether or not to include the presented standards for re-teaching in the current DDP by clicking on boxes identified by the label “Include” (e.g., box 1418). Like the review portion of the example DDP, the IA platform may list those standards that were above the re-teach threshold but below the review threshold (e.g., standard 1419)—those standards marked for teacher-determined—in order for the teacher to determine which, if any, of those standards should also be included for re-teaching.

For all of the included standards, this portion of the DDP may provide text boxes 1420, 1421 for the teacher to insert a diagnosis of the students' failure to master the standards and a plan of action for helping them master the standards on the next IA. The DDP may also include text box 1423 in which the DDP reviewer (school leader) may insert his or her comments on the quality of the DDP. The system user may click on the “Click here to return to step 1 of the Data Driven Plan” link 1424 to return to the previous portion of the DDP, which is the standards-for-review portion in the example DDP of FIG. 14B.

The IA platform of the present disclosure may also analyze the IA questions and flag any individual question on which aggregate classroom performance is at or below the threshold for re-teach. Even if the aggregate standard performance is above this threshold, the fact that a certain question performed so poorly for a class may require a teacher's attention. This process is illustrated in column 2 of data table 1422 of FIG. 14.B. For example, as shown on FIG. 14.B, if aggregate performance on question #7, which was aligned to standard number R.01, was 50% correct, but the overall performance on standard R.01 (including question #7 and two other questions aligned to standard R.01) was 74% and the threshold for re-teach was 70% or less, then question #7 will be listed as a question for re-teach.

This portion of the DDP may give the teacher the option to include or remove a question designated for re-teach (e.g., question #7) by selecting/de-selecting an “Include” box 1429. If the question is included, the teacher may generate a DDP for re-teaching the classroom the concept of question #7, which may be a different aspect of standard R.01 that was not measured or evaluated by the other two questions (question #12 and 13) on the IA. The DDP may provide links 1426, 1427, and 1428 for all of the questions pertaining to the identified standard (including questions that were not flagged for re-teaching) in column 2 of data table 1422. By clicking on links 1426, 1427, or 1428, the DDP may display the respective question in a display or pop-up window.

Struggling Students

The IA platform of the present disclosure may allow a teacher to address students who are struggling with a particular standard or question in a DDP section such as the one illustrated in FIG. 14.C. This DDP section may include a list of students who scored in a particular performance band (e.g., all students in “Not Proficient”) or set of performance bands for one or more standards. For example, the threshold of the performance band used in creating the DDP section on FIG. 14.C may have been pre-set at 70% (in terms of overall points on IA#4A). Two students scored below 70% on both standards R.02 and R.07, whose names are listed below the relevant standards 1432, 1433 in data table 1430. Similarly, one student scored below the struggling student threshold for question number 7 of IA#4A, whose name is listed below the “Question #7” link 1431. By clicking the question links (e.g., link 1431), the teacher may view the respective question in a display or pop-up window.

This aspect of the example DDP may allow the teacher to assign specific actions for teaching the listed struggling students. That is, the teacher may determine what intervention strategies to apply to these struggling students. Such options could include one-on-one tutoring, small-group instruction, after school tutorial, Saturday school, and/or some other teacher-determined action. In the example DDP section shown on FIG. 14.C, the teacher may choose to place struggling students in one or more small groups for additional teaching, have one-on-one class time with the students, or assign the students to a tutor by selecting the appropriate boxes (e.g., box 1435 to designate James Johnson for small group 2) or a link to schedule for one-on-one classroom time 1436 or tutoring 1437 adjacent to the students' names. A student may be scheduled to more than one intervention group, session, or tutor.

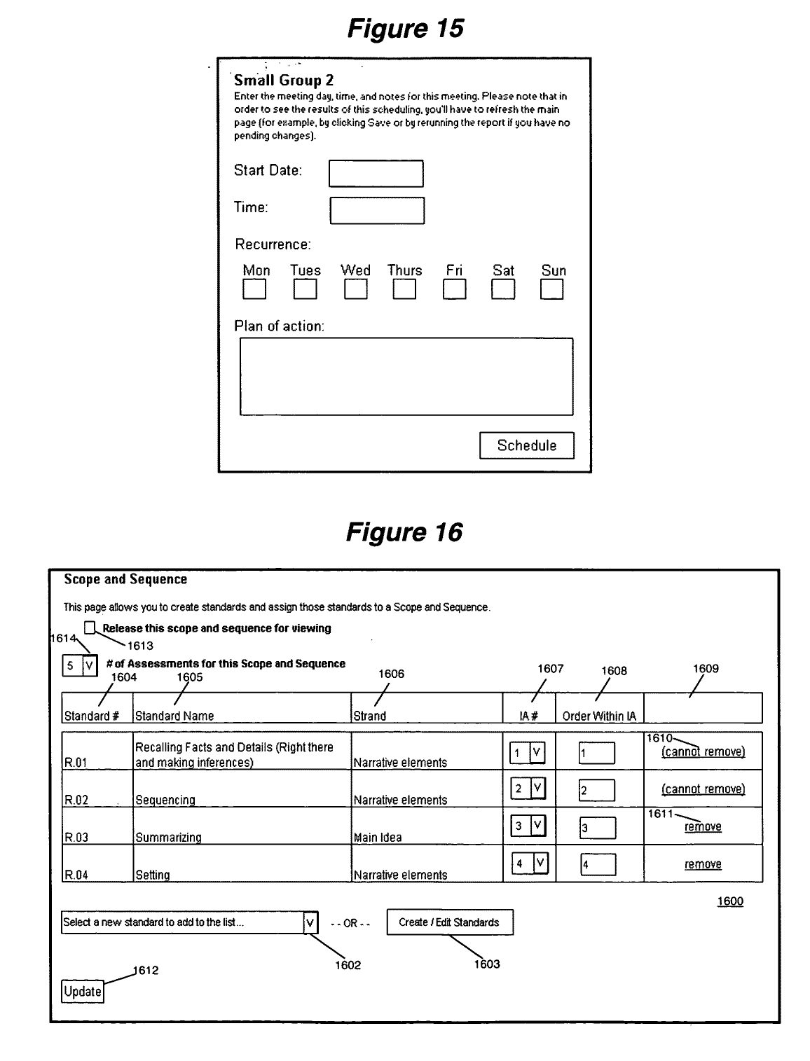

The DDP may allow the teacher to schedule the small group, individual, and tutor sessions by clicking on the schedule links. By clicking on links 1434, 1436, or 1437, for example, a pop-up or display window such as the one illustrated in FIG. 15 may be viewed by the teacher. Using this display window, the teacher may designate the start date of the struggling student intervention session, the time of the intervention session, and determine whether the struggling student interventions will occur regularly on a specific day or days of the week. The teacher may also define in a text box a plan of action, including what content to cover and how to cover that content, for the struggling student interventions, as shown in FIG. 15.

It should be noted that the IA platform of the present disclosure may store educational resources, such as lessons, homework, quizzes, and other instructional aids, that address the specific standards selected to be reviewed or re-taught to the class or individual struggling students. The IA platform may provide links to those resources or allow the teacher to access the educational resources by another means in any or all DDP sections as well as SPRs. As instructional resources are created and loaded into the system linked to specific content standards, teachers may browse and search for resources. The teacher may incorporate the instructional resources into the DDP as part of the strategies for re-teaching or reviewing standards or questions.

Scheduling Instructional Time

According to one aspect of the invention of the present disclosure, the IA platform may determine how much instructional time remains between the date of the creation of the DDP and the administration of the subsequent IA. This process may be illustrated as in FIG. 14.D. The system may prompt the teacher to schedule when actual instruction will occur for reviewing and re-teaching the flagged questions and standards in the second and third rows 1438, 1439, respectively, of the chart shown in FIG. 14.D. The teacher may determine which weeks a review or re-teach activity will occur for each review or re-teach standard until the next IA is scheduled. Additionally, the IA platform may present the teacher with all of the new standards that are scheduled for the students to learn by the subsequent IA (i.e., all of the “new teach” standards) in the fourth row 1440 of the chart shown on FIG. 14.D.

Final Summary of Data-Driven Plan

Once planning steps are completed by the teacher, the IA platform may compile a final summary page of the DDP for the teacher. FIG. 14.E is an example of a DDP summary created using the IA platform of the present disclosure. As shown in this figure, the software application may create a chart 1446 showing the standards that will be reviewed (e.g., standards 1441) or re-taught (e.g., standards 1442) during the subsequent weeks until the next IA. The chart may list the strategies for reviewing or re-teaching, such as using cumulative review homework assignments 1443, do now/quick questions 1444, or other strategies 1445 chosen by the teacher such as tying the standard(s) to a literature passage. The chart may also list the students included in each of the small groups for intervention sessions and the standards to be taught to those students. For example, students James Knoop and James Johnson 1449 have been selected to be included in small group 1 to which standard R.02 (labeled as standard 1450) will be taught, as shown in section 1451 of column 2 of chart 1446. In another aspect of the present disclosure, the DDP summary page may list the instructional aids (not shown) such as homework assignments that the teacher intends on using to supplement his or her reviewing and re-teaching, with a link that may display the stored file of the instructional aid when selected. If the teacher feels that his or her DDP is ready for execution, he or she may select a “Submit Plan for Administrative Approval” button 1447 as shown on FIG. 14.E. By selecting this button, all sections of the DDP may be submitted for approval electronically to a student leader, as described in further detail below.

Data-Driven Plan Approval

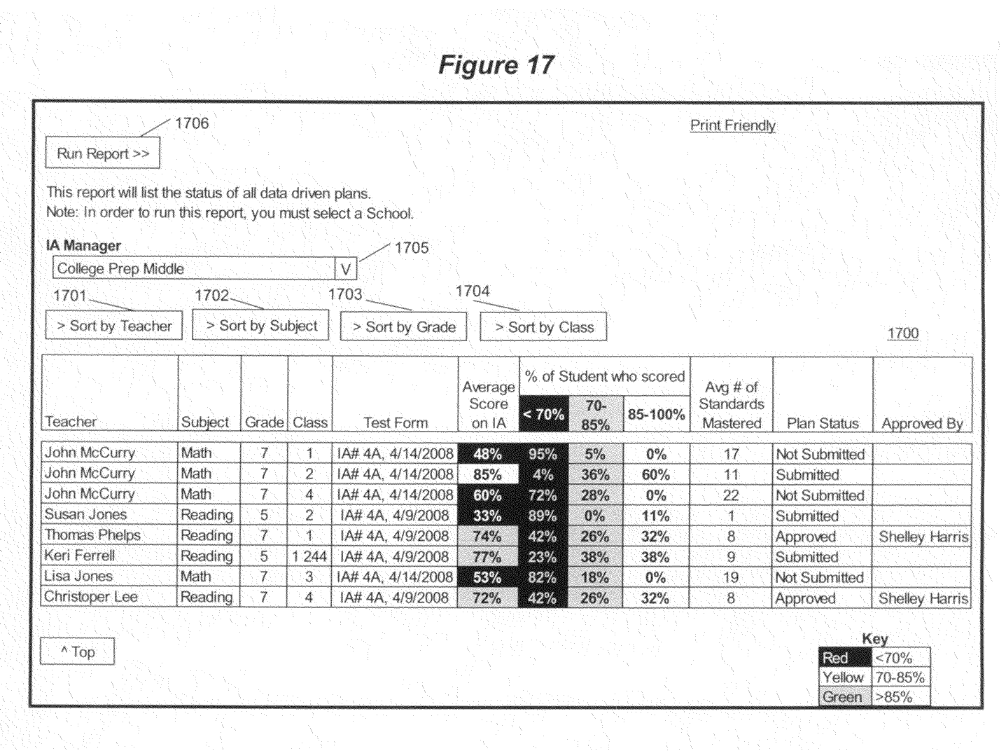

The IA platform may act as a repository of DDPs, and the stored DDPs may be reviewed online by a principal, administrator, or other instructional leader in the school or organization for their approval. Designed to facilitate an online or offline conversation, the DDP may be a mechanism for principals to actively review and coach teachers in the instructional planning process. FIG. 17 illustrates a display screen for an IA manager approval report that may be created by the software application of the present disclosure that may alert school leaders when a teacher's DDP is ready for the school leader's review and approval. By selecting a drop-down box 1705, the system user may choose a particular school for which the user wants to view the status of the teachers' DDPs. To create the report after the user has chosen a school, the user may click on the “Run Report” button 1706.

Running the report may cause the software program to populate a data table 1700 with information pertaining to the teachers of the selected schools. The information in the data table 1700 may identify the teachers in the school (column 1); the subjects taught by the teachers (column 2); the grades taught by the teachers (column 3); the classes (identified by number) taught by the teachers (column 4); the current IAs (by number and date taken by the student) for which the DDP is being or has been submitted (column 5); the average score on those IAs (column 6); the percentage of students who scored below certain designated score thresholds (columns 7, 8, and 9); and the average number of standards for which the students' performance qualified for “Mastered” (column 10). Mastery of a standard may be defined as being dependent, for example, on the number of points possible and number of questions tested. Mastery may be different for each standard depending on the system user's or administrator's preferences and may be defined during the test creation process or set with system-wide policies.

Column 11 of data table 1700 may show whether or not the teacher has submitted the teacher's DDP for approval by a school leader. Column 12 may show which (if any) of the school leaders has approved a particular DDP. For instance, data table 1700 of FIG. 17 indicates that Shelley Harris has approved a DDP submitted by Thomas Phelps for IA#4A. The system user may sort data table 1700 by teacher, subject, grade, or class by clicking buttons 1701, 1702, 1703, or 1704, respectively. When a school leader accesses a stored DDP during the approval process, the school leader may click a button on the DDP summary page (see button 1448 on FIG. 14.E) that submits the DDP, confirms that the DDP has been approved, and updates the data table 1700 of FIG. 17 to reflect this information.

The above aspects of the data-driven plans of the present disclosure are merely illustrative, and additional components could be added depending on such things as the policies of the organization that implement the system. For example, the invention of the present disclosure may include actions designed to assist the education professional in developing a DDP other than the default review, re-teach, and teacher-determined actions. If the organization wants to designate thresholds for standards that should be listed as “extension” or “move to mastery” standards, for instance, they may set aggregate performance bands for those standards and a commensurate step in the DDP will be created for teachers to determine the strategies they will use for standards that qualify in that category.

### Executing a Data-Driven Educational Plan

A further step in the IA platform of the present disclosure may include executing a DDP, as shown in step 8 of FIG. 3. The education professional may review, re-teach, and/or provide instructions to struggling students as may be prescribed in the DDP. After executing a DDP, the education professional may repeat the cycle between steps 3 and 8 of FIG. 3 (including step 9, which will be discussed below in further detail) as many times as the education professional desires. This includes repeating the steps of creating an IA, administering the IA, analyzing the IA results, creating and analyzing an improvement analysis report, developing a DDP, and executing the DDP. By repeating these steps and implementing multiple IAs and DDPs on the same educational standards, a teacher may increase the effectiveness of the IA platform of the present disclosure and thus the performance of the teacher's students.

### Creating an Improvement Analysis Report

The software application of the present disclosure may allow education professionals to create “improvement analysis reports” to track the effectiveness of their DDPs after two or more IAs have been taken by the students, as shown in step 9 of FIG. 3. By comparing past student performance in a prior IA, the improvement analysis report may be analyzed to create a new IA which is more or less difficult based on the teacher's or administrator's preferences.

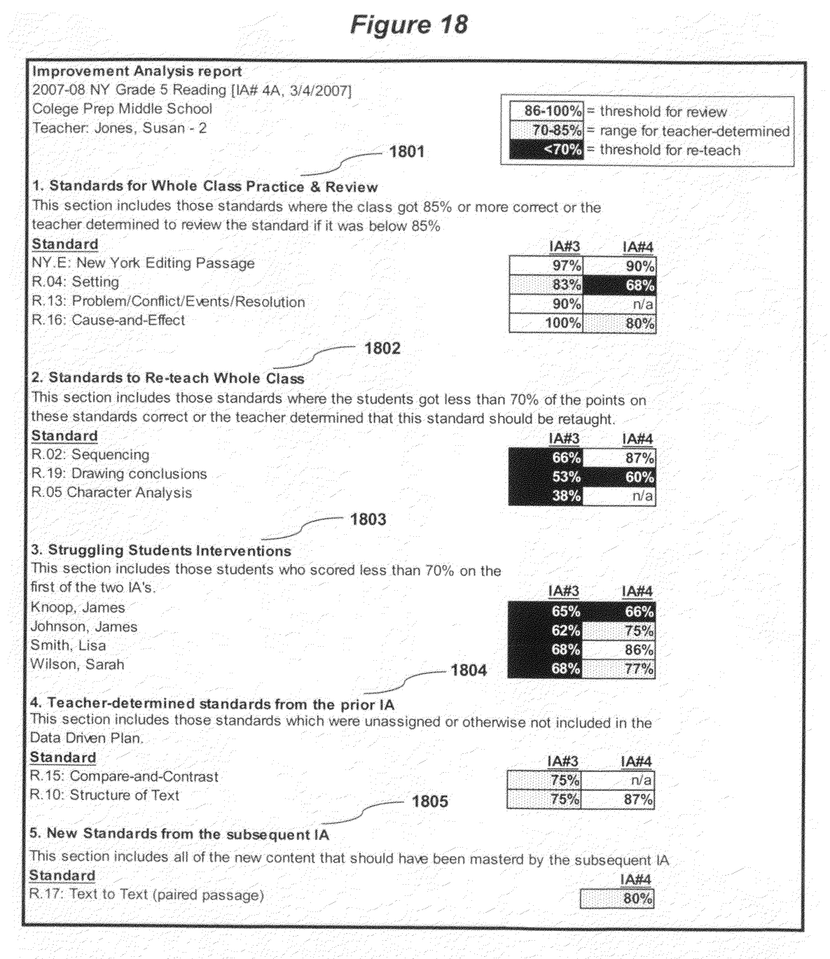

An example improvement analysis report created using the software program of the present disclosure may be illustrated as in FIG. 18. As shown in FIG. 18, the software program may create an improvement analysis report that evaluates the standards that were designated for follow-up action in a DDP from the preceding IA cycle (e.g., IA#3) against the classroom's performance on those same standards during a subsequent IA cycle (e.g., IA#4). An improvement analysis report may show the scores for each of the selected standards on the preceding and subsequent IAs. A system user may configure the software application to coordinate the blocks containing the scores of each IA cycle by designation or color based on whether they qualify for particular instructional actions such as “review,” “re-teach,” “teacher-determined,” or other customized action chosen by the education professional. In FIG. 18, the blocks containing the scores for standards meeting the review, re-teach, and teacher-determined thresholds are colored white, black, and dotted white, respectively, but may be color-coded differently based on the system user's or administrator's preferences.

A section 1801 of the improvement analysis report of FIG. 18 may track the performance on standards designated for review. If both scores in a first IA and second IA cycle keep a standard in review, then the system user may see two scores in blocks colored for review beside that standard (e.g., standard number NY.E). If a review standard was not measured on the subsequent IA, the data under the subsequent IA column may indicate that the measure is not applicable (e.g., standard number R.13).

Another section 1802 of an improvement analysis report according to the example in FIG. 18 may track the performance on the standards designated for re-teach. Each standard that is designated for re-teach on the DDP from the prior IA may be shown with the aggregate performance score from the prior IA and the aggregate performance score on the subsequent IA. If a re-teach standard was not measured on the subsequent IA, the data under the subsequent IA column may indicate that the measure is not applicable (e.g., standard number R.05).

A section 1803 of FIG. 18 may track the performance of students who qualified as “struggling students” based on their performance in the first of two IAs. This section 1803 may include a list of the names of those students and may show how they performed in the subsequent IA presumably after the teacher conducted an intervention. These students' scores from the prior IA and the subsequent IA may be listed side by side, as shown in FIG. 18, to enable quick analysis of whether or not each student had shown growth in performance and by how much.

An additional section 1804 of the improvement analysis report in FIG. 18 may track all of those standards from the prior IA and DDP that were teacher-determined or that the teacher removed from either the review or re-teach lists. The improvement analysis report may track ongoing performance against those standards showing prior IA performance and subsequent IA performance. If one or more of the standards was not measured on the subsequent IA, the data under the subsequent IA column may indicate that the measure is not applicable (e.g., standard number R.15). The improvement analysis report may also contain a section 1805 that tracks aggregate student performance on the new standards scheduled to be taught to students in the last IA cycle and may report the scores on those standards.

### Evaluating Overall Results of IA Platform

As shown as step 10 in FIG. 3, the education professional may evaluate the overall results of the IA platform. The education professional may analyze the aggregate results on a number of IAs against, for example, state standardized tests to determine how to improve or change the scope and sequence of the IAs for the following school year or education cycle. The education professional may analyze the overall IA platform results for macro planning for curriculum and professional development needs.

Although illustrative embodiments have been shown and described herein in detail, it should be noted and will be appreciated by those skilled in the art that there may be numerous variations and other embodiments that may be equivalent to those explicitly shown and described. Unless otherwise specifically stated, terms and expressions have been used herein as terms of description, not of limitation. Accordingly, the invention is not to be limited by the specific illustrated and described embodiments or the terms or expressions used to describe them, but only by the scope of the following claims.

1-3. (canceled)

4. A method for using data generated from a student assessment to develop an action plan for improving student understanding of one or more educational standards, the method performed in a computer having a memory and a processor, comprising the steps of:
a. receiving, by the computer, first data corresponding to one or more designated thresholds by which student understanding of one or more educational standards is to be measured;
b. generating, by the processor of a computer, a first assessment that includes one or more questions assessing said educational standards;
c. receiving, by the computer, second data corresponding to a student's performance on said first assessment, said student having answered said questions included in said first assessment;
d. comparing, by the processor of the computer, said first and second data to determine if said student's performance is below one or more of said designated thresholds; and
e. creating, by the processor, an action plan based on said comparison, said action plan identifying one or more designated techniques for improving student understanding of at least one of said assessed standards.

5. The method of claim 4, wherein step b is performed before step a.

6. The method of claim 4, wherein said designated techniques for improving student understanding includes one or more of re-teaching and reviewing.

7. The method of claim 6, wherein said designated techniques for improving student understanding further includes a technique designated by a teacher who administered said first assessment to said student.

8. The method of claim 4, wherein a particular technique for improving student understanding is designated for a particular assessed standard according to which of said designated thresholds said student's performance was below for that particular assessed standard.

9. The method of claim 4, further including the step of storing a third data representing said action plan in the memory of the computer.

10. The method of claim 9, wherein said third data is stored in a location of the memory of the computer based on one or more of said student's class, teacher, school, and school district.

11. The method of claim 4, further including the step of generating, by the processor, a student performance report based on said second data, said student performance report providing information corresponding to said student's performance on said first assessment.

12. The method of claim 11, wherein the step of generating a student performance report is performed after step d and before step e.

13. The method of claim 11, wherein said information corresponding to said student's performance includes an identifier of said student and a percentage of a total number of questions included in said first assessment that were answered correctly or incorrectly by said student.

14. The method of claim 13, wherein said identifier is a name of said student.

15. The method of claim 11, wherein said information corresponding to said student's performance is provided in a matrix table in said student performance report, said matrix table being sortable by one or more of question, standard, percentage correct, percentage incorrect, question type, student name, and student score.

16. The method of claim 15, wherein the standards assessed on said first assessment are identified in said matrix table by color coding according to said comparison of said first and second data.

17. The method of claim 4, further including the step of generating a second assessment that includes one or more questions assessing one or more of the same standards assessed in said first assessment.

18. The method of claim 17, wherein said standards being assessed in said second assessment are selected based on said comparison of the first and second data.

19. The method of claim 4, further including the step of executing said action plan.

20. The method of claim 17, further including the step of repeating steps c through e for said second assessment after said action plan has been executed for said first assessment.

21. The method of claim 20, further including the step of generating, by the processor, an improvement analysis report, said improvement analysis report comparing said student's performance on said first assessment with said student's performance on said second assessment.

22. The method of claim 21, wherein the step of generating an improvement analysis report is performed after step c and before step d.

23. The method of claim 21, wherein said improvement analysis report includes at least one standard assessed in said second assessment, a percentage of total questions corresponding to said included standard answered correctly or incorrectly by said student on said first assessment, and a percentage of total questions corresponding to said included standard answered correctly or incorrectly by said student on said second assessment.

24. The method of claim 23, wherein said included standard and included percentages are provided in a location on said improvement analysis report according to the particular technique for improving student understanding that was designated for said included standard in the action plan that corresponds to said first assessment.

25. The method of claim 23, wherein said included standard and included percentages are color coded in said improvement analysis report according to said comparison of the first and second data.

26. The method of claim 4, further including the step of displaying said action plan on a display screen of said computer.

27. The method of claim 11, further including the step of storing third data corresponding to said student performance report in a location of the memory of the computer based on one or more of said student's class, teacher, school, and school district.

28. The method of claim 21, further including the step of storing third data corresponding to said improvement analysis report in a location of the memory of the computer based on one or more of said student's class, teacher, school, and school district.

29. The method of claim 4, further including the step of printing a paper version of said action plan using a printer linked to said computer.

30. A computer readable medium having computer executable software code stored thereon, the code for using data generated from a student assessment to develop an action plan for improving student understanding of one or more educational standards, the code comprising:
code for receiving first data corresponding to one or more designated thresholds by which student understanding of one or more educational standards is to be measured;
code for generating a first assessment that includes one or more questions assessing said educational standards;
code for receiving second data corresponding to a student's performance on said first assessment, said student having answered said questions included in said first assessment;
code for comparing said first and second data to determine if said student's performance is below one or more of said designated thresholds; and
code for creating an action plan based on said comparison, said action plan identifying one or more designated techniques for improving student understanding of at least one of said assessed standards.

31. The computer readable medium of claim 30, wherein at least one of said designated techniques for improving student understanding includes re-teaching or reviewing.

32. The computer readable medium of claim 31, wherein at least one of said designated techniques for improving student understanding further includes a technique designated by a teacher who administered said first assessment to said student.

33. The computer readable medium of claim 30, wherein a particular technique for improving student understanding is designated for a particular assessed standard according to which of said designated thresholds said student's performance was below for that particular assessed standard.

34. The computer readable medium of claim 30, further including code for storing a third data representing said action plan in a memory of a computer.

35. The computer readable medium of claim 34, wherein said third data is stored in a location of said memory of said computer based on one or more of said student's class, teacher, school, and school district.

36. The computer readable medium of claim 30, further including code for generating a student performance report based on said second data, said student performance report providing information corresponding to said student's performance on said first assessment.

37. The computer readable medium of claim 36, wherein said information includes an identifier of said student and a percentage of a total number of questions included in said first assessment that were answered correctly or incorrectly by said student.

38. The computer readable medium of claim 37, wherein said identifier is a name of said student.

39. The computer readable medium of claim 36, wherein said information is provided in a matrix table in said student performance report, said matrix table being sortable by one or more of question, standard, percentage correct, percentage incorrect, question type, student name, and student score.

40. The computer readable medium of claim 39, wherein the standards assessed on said first assessment are identified in said matrix table by color coding according to said comparison of said first and second data.

41. The computer readable medium of claim 30, further including code for generating a second assessment that includes one or more questions assessing one or more of the same standards assessed in said first assessment.

42. The computer readable medium of claim 41, wherein said standards being assessed in said second assessment are selected according to said comparison of the first and second data.

43. The computer readable medium of claim 41, further including code for receiving first data, code for receiving second data, code for comparing said first and second data, and code for creating an action plan, for said second assessment.

44. The computer readable medium of claim 43, further including code for generating an improvement analysis report, said improvement analysis report comparing said student's performance on said first assessment with said student's performance on said second assessment.

45. The computer readable medium of claim 44, wherein said improvement analysis report includes at least one standard assessed in said second assessment, a percentage of total questions corresponding to said included standard answered correctly or incorrectly by said student on said first assessment, and a percentage of total questions corresponding to said included standard answered correctly or incorrectly by said student on said second assessment.

46. The computer readable medium of claim 45, wherein said included standard and included percentages are provided in a location on said improvement analysis report according to the particular technique for improving student understanding that was designated for said included standard in the action plan that corresponds to said first assessment.

47. The computer readable medium of claim 45, wherein said included standard and included percentages are color coded on said improvement analysis report according to said comparison of the first and second data.

48. The computer readable medium of claim 30, further including code for displaying said action plan on a display screen of a computer.

49. The computer readable medium of claim 36, further including code for storing third data corresponding to said student performance report in a location of a memory of a computer based on one or more of said student's class, teacher, school, and school district.

50. The computer readable medium of claim 44, further including code for storing third data corresponding to said improvement analysis report in a location of a memory of a computer based on one or more of said student's class, teacher, school, and school district.

51. The computer readable medium of claim 30, further including code for printing a paper version of said action plan.

52. A programmed computer for using data generated from a student assessment to develop an action plan for improving student understanding of one or more educational standards, comprising:
a memory at least partially for storing computer executable program code; and
a processor for executing the program code stored in the memory, wherein the program code includes:
code for receiving first data corresponding to one or more designated thresholds by which student understanding of one or more educational standards is to be measured;
code for generating a first assessment that includes one or more questions assessing said educational standards;
code for receiving second data corresponding a student's performance on said first assessment, said student having answered said questions included in said first assessment;
code for comparing said first and second data to determine if said student's performance is below one or more of said designated thresholds; and
code for creating an action plan based on said comparison, said action plan identifying one or more designated techniques for improving student understanding of at least one of said assessed standards.

53. The programmed computer of claim 52, wherein at least one of said designated techniques for improving student understanding includes re-teaching or reviewing.

54. The programmed computer of claim 53, wherein at least one of said designated techniques for improving student understanding further includes a technique designated by a teacher who administered said first assessment to said student.

55. The programmed computer of claim 52, wherein a particular technique for improving student understanding is designated for a particular assessed standard according to which of said designated thresholds said student's performance was below for that particular assessed standard.

56. The programmed computer of claim 52, further including code for storing a third data representing said action plan in a memory of a computer.

57. The programmed computer of claim 56, wherein said third data is stored in a location of said memory of said computer based on one or more of said student's class, teacher, school, and school district.

58. The programmed computer of claim 52, further including code for generating a student performance report based on said second data, said student performance report providing information corresponding to said student's performance on said first assessment.

59. The programmed computer of claim 58, wherein said information includes an identifier of said student and a percentage of a total number of questions included in said first assessment that were answered correctly or incorrectly by said student.

60. The programmed computer of claim 59, wherein said identifier is a name of said student.

61. The programmed computer of claim 58, wherein said information is provided in a matrix table in said student performance report, said matrix table being sortable by one or more of question, standard, percentage correct, percentage incorrect, question type, student name, and student score.

62. The programmed computer of claim 61, wherein the standards assessed on said first assessment are identified in said matrix table by color coding according to said comparison of said first and second data.

63. The programmed computer of claim 52, further including code for generating a second assessment that includes one or more questions assessing one or more of the same standards assessed in said first assessment.

64. The programmed computer of claim 63, wherein said standards being assessed in said second assessment are selected according to said comparison of the first and second data.

65. The programmed computer of claim 64, further including code for receiving first data, code for receiving second data, code for comparing said first and second data, and code for creating an action plan, for said second assessment.

66. The programmed computer of claim 65, further including code for generating an improvement analysis report, said improvement analysis report comparing said student's performance on said first assessment with said student's performance on said second assessment.

67. The programmed computer of claim 66, wherein said improvement analysis report includes at least one standard assessed in said second assessment, a percentage of total questions corresponding to said included standard answered correctly or incorrectly by said student on said first assessment, and a percentage of total questions corresponding to said included standard answered correctly or incorrectly by said student on said second assessment.

68. The programmed computer of claim 67, wherein said included standard and included percentages are provided in a location on said improvement analysis report according to the particular technique for improving student understanding that was designated for said included standard in the action plan that corresponds to said first assessment.

69. The programmed computer of claim 67, wherein said included standard and included percentages are color coded on said improvement analysis report according to said comparison of the first and second data.

70. The programmed computer of claim 52, further including code for displaying said action plan on a display screen of a computer.

71. The programmed computer of claim 58, further including code for storing third data corresponding to said student performance report in a location of a memory of a computer based on one or more of said student's class, teacher, school, and school district.

72. The programmed computer of claim 66, further including code for storing third data corresponding to said improvement analysis report in a location of a memory of a computer based on one or more of said student's class, teacher, school, and school district.

73. The programmed computer of claim 52, further including code for printing a paper version of said action plan.
